(19) United States
(12) Patent Application Publication
(10) Pub. No.: US 2019/0172292 A1
(43) Pub. Date: Jun. 6, 2019

(54) MONEY HANDLING DEVICE AND MONEY HANDLING METHOD

(71) Applicant: GLORY LTD., Himeji-shi, Hyogo (JP)

(72) Inventors: Koki FUKUDA, Hyogo (JP); Kisho YANASE, Hyogo (JP); Masashi KUWADA, Hyogo (JP); Masatoshi KAGEYAMA, Hyogo (JP); Akiyoshi TAKENAKA, Hyogo (JP)

(21) Appl. No.: 16/321,080

(22) PCT Filed: Jul. 20, 2017
(86) PCT No.: PCT/JP2017/026364

§ 371 Date: Jan. 28, 2019

(30) Foreign Application Priority Data
Jul. 29, 2016 (JP) 2016-149362
Jul. 29, 2016 (JP) 2016-149363

(51) Int. Cl. G07D 11/18; G07D 11/50; G07D 11/13; G07D 11/245

(52) U.S. Cl. CPC G07D 11/18; G07D 11/50; G07D 2211/00; G07D 11/245; G07D 11/13

(57) ABSTRACT

A money handling apparatus (banknote handling apparatus 1) includes: a transporter 4 which includes a first route for the money that passes through a recognition unit 24 and a second route for the money that does not pass through the recognition unit 24, and wherein the transporter is operable to transport the money from a first storage to a second storage along either the first route or the second route; and a controller (controller 15) which, in a process of storing the money fed from the first storage into the second storage, selects either the first route or the second route for the money in accordance with a specific condition.

### TECHNICAL FIELD

The present disclosure relates to a money handling apparatus and a money handling method.

### BACKGROUND ART

Patent Document 1 discloses a banknote handling apparatus. A removable cassette can be attached to this banknote handling apparatus outside a safe housing. Banknotes fed from a storage assembly in the safe housing are stored in the removable cassette to collect the banknotes.

Patent Document 2 describes an automatic transaction apparatus. This automatic transaction apparatus performs a reconciliation process to accept an inventory amount of banknotes stored in a safe which stores the banknotes sorted by kind. If some banknotes are rejected during the reconciliation process, the automatic transaction apparatus stores the rejected banknotes to a storage dedicated to the rejected banknotes.

### CITATION LIST

### Patent Documents

[Patent Document 1] U.S. Pat. No. 8,708,127

[Patent Document 2] Japanese Unexamined Patent Publication No. H09-22476

### SUMMARY OF THE INVENTION

### Technical Problem

In the banknote handling apparatus of Patent Document 1, banknotes fed from the storage assembly to be stored in the removable cassette travel through a route that does not pass through an analysis assembly. This banknote handling apparatus cannot change the route through which the banknotes pass.

### Solution to the Problem

The present disclosure changes the route for transporting the money.

Specifically, the present disclosure relates to a money handling apparatus. The money handling apparatus includes: a first storage and a second storage each of which stores money;

a recognition unit which is operable to recognize the money passing therethrough; a transporter which includes a first route for the money that passes through the recognition unit and a second route for the money that does not pass through the recognition unit, and wherein the transporter is operable to transport the money from the first storage to the second storage along either the first route or the second route; and a controller which, in a process of storing the money fed from the first storage into the second storage, selects either the first route or the second route in accordance with a specific condition.

### Advantages of the Invention

The above-described money handling apparatus can change the route for transporting the money in the money handling apparatus.

### BRIEF DESCRIPTION OF THE DRAWINGS

FIG. 1 illustrates an appearance of a banknote handling apparatus.

FIG. 2 schematically illustrates a basic configuration example of the interior of the banknote handling apparatus.

FIG. 3, corresponding to FIG. 2, illustrates a configuration example of a banknote handling apparatus to which an external storage is attached.

FIG. 4, corresponding to FIG. 3, illustrates a configuration example of a banknote handling apparatus to which a temporary storage and an external storage are attached.

FIG. 5 is a block diagram illustrating a configuration example of a banknote handling apparatus.

FIG. 6, corresponding to FIG. 2, illustrates a route for transporting banknotes in a depositing process.

FIG. 7, corresponding to FIG. 2, illustrates another route for transporting banknotes in the depositing process.

FIG. 8, corresponding to FIG. 2, illustrates a route for transporting banknotes when the deposit is canceled.

FIG. 9, corresponding to FIG. 2, illustrates a route for transporting banknotes in a dispensing process.

FIG. 10, corresponding to FIG. 2, illustrates a route for transporting banknotes in a replenishment process using a depositing unit.

FIG. 11, corresponding to FIG. 2, illustrates a route for transporting banknotes in a replenishment process using a multi-purpose storage.

FIG. 12, corresponding to FIG. 3, illustrates a first route for transporting banknotes in a replenishment process using an external storage.

FIG. 13, corresponding to FIG. 3, illustrates a second route for transporting banknotes in the replenishment process using the external storage.

FIG. 14, corresponding to FIG. 4, illustrates a route for transporting banknotes rejected in the replenishment process using the external storage.

FIG. 15, corresponding to FIG. 3, illustrates another route for transporting banknotes rejected in the replenishment process using the external storage.

FIG. 16, corresponding to FIG. 3, illustrates a first route for transporting banknotes in a collection process using the external storage.

FIG. 17, corresponding to FIG. 3, illustrates a second route for transporting banknotes in the collection process using the external storage.

FIG. 18, corresponding to FIG. 2, illustrates a route for transporting banknotes in a collection process using a multi-purpose storage.

FIG. 19, corresponding to FIG. 3, illustrates a route for transporting banknotes in a collection process of collecting banknotes from the multi-purpose storage to the external storage.

FIG. 20, corresponding to FIG. 3, illustrates a route for transporting banknotes in a high-level reconciliation process using the external storage.

FIG. 21, corresponding to FIG. 3, illustrates a route for transporting banknotes in a mid-level reconciliation process using the external storage.

FIG. 22, corresponding to FIG. 3, illustrates a route for transporting banknotes in a low-level reconciliation process using the external storage.

FIG. 23, corresponding to FIG. 3, illustrates a route for transporting banknotes in a reconciliation process performed on the multi-purpose storage using the external storage.

FIG. 24, corresponding to FIG. 4, illustrates a route for transporting banknotes in a reconciliation process performed on the multi-purpose storage using the external storage and the temporary storage.

FIG. 25, corresponding to FIG. 3, illustrates a route for transporting banknotes in a reconciliation process sequentially performed on a plurality of storages.

FIG. 26, corresponding to FIG. 2, illustrates a route for transporting banknotes in a reconciliation process using an available capacity of another storage.

FIG. 27, corresponding to FIG. 4, illustrates a route for transporting banknotes in a reconciliation process performed on a small storage using the temporary storage.

FIG. 28 is a flowchart illustrating a control procedure executed by a controller in a process using the external storage.

FIG. 29, corresponding to FIG. 4, illustrates a second configuration example of the banknote handling apparatus to which the present disclosure is applicable.

FIG. 30, corresponding to FIG. 29, illustrates a route for transporting banknotes in a depositing process in the second configuration example.

FIG. 31, corresponding to FIG. 29, illustrates a route for transporting banknotes in a dispensing process in the second configuration example.

FIG. 32, corresponding to FIG. 29, illustrates a route for transporting banknotes in a replenishment process using an external storage in the second configuration example.

FIG. 33, corresponding to FIG. 29, illustrates a route for transporting banknotes in a collection process using the external storage in the second configuration example.

FIG. 34, corresponding to FIG. 29, illustrates a route for transporting banknotes in a reconciliation process using the external storage in the second configuration example.

FIG. 35, corresponding to FIG. 4, illustrates a third configuration example of the banknote handling apparatus to which the present disclosure is applicable.

FIG. 36, corresponding to FIG. 4, illustrates a fourth configuration example of a banknote handling apparatus to which the present disclosure is applicable.

FIG. 37, corresponding to FIG. 2, illustrates a fifth configuration example of the banknote handling apparatus to which the present disclosure is applicable.

### DESCRIPTION OF EMBODIMENTS

Specifically, the present disclosure relates to a money handling apparatus. The money handling apparatus includes: a first storage and a second storage each of which stores money; a recognition unit which is operable to recognize the money passing therethrough; and a transporter which includes a first route for the money that passes through the recognition unit and a second route for the money that does not pass through the recognition unit, and wherein the transporter is operable to transport the money from the first storage to the second storage along either the first route or the second route; and a controller which, in a process of storing the money fed from the first storage in the second storage, selects either the first route or the second route in accordance with a specific condition.

When the first route is selected, the money can be recognized. When the second route is selected, the recognition of the money can be skipped. The route for transporting the money changes depending on the selection of the route in accordance with a specific condition.

The second route may be shorter than the first route.

When the second route is selected, time required for the transport of the money is shortened.

One of the first storage and the second storage may be disposed inside a safe housing, and the other one of the first storage and the second storage may be disposed outside the safe housing.

When the money is transported between the storage disposed inside the safe housing and the storage disposed outside the safe housing, a route for transporting the money changes in accordance with a specific condition.

In a replenishment process of storing the money fed from the first storage disposed outside the safe housing in the second storage disposed inside the safe housing, the controller may select either the first route or the second route in accordance with the specific condition.

The route for transporting the money changes in the replenishment process.

The controller may select the second route if data about the money stored in the first storage has been acquired, and may select the first route if the data about the money stored in the first storage has not been acquired.

If the data about the money has been acquired, the recognition of the money for the replenishment can be skipped. Selecting the second route which is not accompanied by the recognition of the money shortens time required for the replenishment process.

If the data about the money has not been acquired, the first route is selected. The data about the money to be stored in the second storage is acquired through the recognition of the money.

The money handling apparatus may further include a reader which reads data about the money stored in the first storage from a memory storing the data. The reader may be disposed outside the safe housing.

The reader reads the data outside the safe housing, thereby acquiring the data about the money for replenishment. There is no need to open the safe housing in the replenishment process.

The safe housing has a door which is openable and closable, and the money handling apparatus further includes a cover attached to cover the door. The reader may be disposed between the door of the safe housing and the cover when the cover is closed.

The reader is covered with the cover. This can prevent unauthorized access to the reader (e.g., unauthorized reading of data). As a result, the security level of the money handling apparatus improves.

The controller may select either the first route or the second route in accordance with the specific condition in a collection process of storing the money fed from the first storage disposed inside the safe housing in the second storage disposed outside the safe housing.

The route for transporting the money changes in the collection process.

The controller may select the first route in collecting a designated number of the money from the first storage, and may select the second route in collecting all the money stored in the first storage.

The money can be counted through the recognition of the money. If the first route is selected for the collection of a designated number of money, the money can be counted, and the designated number of money can be collected.

In collecting all the money stored in the first storage, counting of the money is not necessary. Selecting the second route can shorten time required for the collection process.

The controller may select the first route if the number of money to be collected from the first storage is less than a predetermined number, and may select the second route if the number of money to be collected from the first storage is more than or equal to the predetermined number.

When the number of money to be collected is small, the collection process does not take a long time even if the first route which is accompanied by the recognition of the money is selected.

Selecting the second route which is not accompanied by the recognition of the money shortens the time required for the collection process even if a greater number of money needs to be collected.

The controller may select either the first route or the second route in accordance with the specific condition in a reconciliation process of storing the money fed from the first storage in the second storage, and storing the money fed from the second storage in the first storage.

The route for transporting the money changes in the reconciliation process.

The controller may select either the first route or the second route in accordance with the specific condition in transporting the money from the first storage to the second storage, and in transporting the money from the second storage to the first storage.

In the reconciliation process, the money travels from the first storage to the second storage, and vice versa. A route from the first storage to the second storage, and an inverse route from the second storage to the first storage are individually selected.

In accordance with a reconciliation level of the reconciliation process, the controller may select the first route in transporting the money from the first storage to the second storage, and may select the first route in transporting the money from the second storage to the first storage.

The money will pass through the recognition unit twice. This can achieve a high-level reconciliation process.

In accordance with the reconciliation level of the reconciliation process, the controller may select the second route in transporting the money from the first storage to the second storage, and may select the second route in transporting the money from the second storage to the first storage.

The money does not pass through the recognition unit. The money may only be counted using a tracking sensor arranged in the middle of the transport path. This can achieve a low-level reconciliation process, and greatly shorten time required for the reconciliation process.

In accordance with a reconciliation level of the reconciliation process, the controller may select either the first route or the second route in transporting the money from the first storage to the second storage, and selects the other one of the first or second route in transporting the money from the second storage to the first storage.

The money passes through the recognition unit once, which can achieve a mid-level reconciliation process. Further, time required for the reconciliation process is relatively shortened.

If the recognition unit has recognized money to be rejected during a process of transporting the money through the first route, the controller may stop the feeding of the money from the first storage.

Part of the first route from the first storage to the recognition unit may intersect with a route from the recognition unit to a destination of the rejected money.

If the routes intersect with each other, priority should be given to either of the routes. Transporting the rejected money in preference to the feeding of the money from the first storage allows the rejected money to be smoothly transported to the destination.

The controller may resume the feeding of the money from the first storage after the rejected money has been transported to a predetermined destination.

The process is immediately resumed after the rejected money has been transported.

The money handling apparatus may further include a temporary storage which temporarily stores the money, and feeds the stored money.

If the recognition unit has recognized money to be rejected during a process of transporting the money through the first route, the controller may transport the rejected money to the temporary storage to be stored therein.

This makes it possible to keep the rejected money in the temporary storage during the process.

The controller may feed the money stored in the temporary storage, and transport the money to a predetermined destination after the end of the process of transporting the money.

This can empty the temporary storage after the end of the transport of the money.

The recognition unit may recognize the money fed from the temporary storage again, and the controller may determine the destination of the money based on the result of the recognition by the recognition unit.

The rejected money is transported to an appropriate destination in accordance with the result of the second recognition.

The temporary storage may be disposed in the middle of the first route from the recognition unit to the second storage.

This makes it possible to transport the rejected money to the temporary storage without stopping the feeding of the money from the first storage during the process. Thus, the process proceeds smoothly.

The temporary storage may be attachable to and detachable from the inside of a body of the apparatus.

The temporary storage can be removed from the apparatus, if unnecessary.

If the recognition unit has recognized money to be rejected during a process of transporting the money through the first route, the controller may transport the rejected money to a third storage to be stored therein, the third storage being disposed inside the safe housing.

Since the rejected money accumulates in the safe housing, the security level of the money handling apparatus improves.

Either the first route or the second storage may be a removable storage which is attachable to and detachable from a body of the apparatus outside the safe housing, and the money handling apparatus may further include a detection unit which detects that the removable storage is attached to the body of the apparatus.

The controller may start the process when the detection unit has detected attachment of the removable storage.

Thus, the process using the removable storage suitably starts.

The controller may stop the process currently performed when the detection unit has detected detachment of the removable storage.

This allows the process using the removable storage to be suitably interrupted, thereby performing the process correctly.

The removable storage may include a memory storing data about the money stored in the removable storage.

The data stored in the memory can be used to perform the process.

The money handling apparatus may further include a setting unit which sets the specific condition.

The specific condition may include a condition concerning a use environment of the money handling apparatus.

The route for transporting the money is suitably selected depending on the use environment of the money handling apparatus.

The present disclosure also relates to a money handling method. The money handling method includes: selecting either a first route that passes through a recognition unit or a second route that does not pass through the recognition unit in accordance with a specific condition in a process of storing money fed from a first storage in a second storage; and transporting the money from the first storage to the second storage through the selected route. The recognition unit recognizes the money if the first route is selected, and the recognition unit does not recognize the money if the second route is selected.

In the automatic transaction apparatus of Patent Document 2, a human has to manually take out the banknotes stored in rejected banknote storage.

The present disclosure also aims to reduce steps of the reconciliation process.

Specifically, the present disclosure relates to a money handling apparatus. The money handling apparatus includes: a recognition unit which recognizes money; a storage which stores money recognized by the recognition unit as money to be rejected, and a controller which allows the storage to feed the money stored therein, and allows the recognition unit to recognize the money, thereby performing a reconciliation process of accepting an inventory amount of the storage.

The controller can perform reconciliation on the storage storing the rejected money.

The storage may store money recognized by the recognition unit as money to be rejected in a dispensing process of dispensing the money stored in the other storage.

The controller can perform reconciliation on the storage storing the money rejected during the dispensing process.

The storage may store money recognized by the recognition unit as money to be rejected during a reconciliation process of accepting an inventory amount of the other storage.

The controller can perform reconciliation on the storage storing the money rejected during the reconciliation process.

In performing the reconciliation process on the storage and the other storage, the controller may last perform the reconciliation process on the former storage.

If some money is rejected during the reconciliation process on the other storage, the rejected money is stored in the former storage, and the ongoing reconciliation process does not need to stop. Thus, the reconciliation process can smoothly proceed.

The money rejected during the reconciliation process on the other storage is stored in the former storage, and is subjected to the reconciliation process again when the reconciliation process is performed on the former storage. In the reconciliation process, for example, money that is transported abnormally and money of incorrect denomination (e.g., money whose denomination is different from the one to be stored is fed from the storage) are recognized as money to be rejected. Recognizing the money twice can reduce the number of rejected money. This can reduce the possibility that the inventory amount of the storage cannot be accepted after the reconciliation process.

The controller may perform a depositing process of taking the money into the apparatus, and the storage may store the money taken into the apparatus in the depositing process.

The storage may store the money that is taken into the apparatus in the depositing process and that cannot be stored in the other storage.

The controller may perform a dispensing process of dispensing the money in the apparatus, and the storage may store the money to be dispensed in the dispensing process.

The storage may be disposed inside the safe housing.

The money handling apparatus may include a second storage disposed outside the safe housing. The controller may transport the money fed from the storage in the reconciliation process to the second storage to be stored therein, and may transport the money fed from the second storage to the storage to be stored therein. The recognition unit may recognize the money being transported between the storage and the second storage.

The reconciliation process is performed using the second storage disposed outside the safe housing. Thus, a storage for the reconciliation process is no longer required inside the safe housing. This can advantageously downsize the money handling apparatus. In addition, the capacity of the money handling apparatus advantageously increases.

The second storage is attachable to and detachable to a body of the apparatus. The controller may perform the reconciliation process upon receiving a detection signal indicating that the second storage is attached to the body of the apparatus.

Thus, the reconciliation process can be suitably performed using the removable second storage.

The money handling apparatus includes a temporary storage which temporarily stores the money, and feeds the stored money. If the reconciliation process is performed on the storage whose maximum storage capacity is less than a predetermined level, the controller may transport the money fed from the storage to the temporary storage to be stored therein, and transport the money fed from the temporary storage to the storage to be stored therein.

The reconciliation process can be performed on the storage whose maximum storage capacity is small using the temporary storage. If the temporary storage is a winding storage, the reconciliation process whose target is the rejected money can be performed with reliability.

If the reconciliation process is performed on the storage whose storage capacity is less than a predetermined level, the controller may transport the money fed from the storage to the temporary storage to be stored therein, and transport the money fed from the temporary storage to the storage to be stored therein.

The reconciliation process can be performed on the storage in which the amount of money as the target of the reconciliation is small using the temporary storage.

The controller may transport money recognized by the recognition unit as money to be rejected during the reconciliation process performed on the storage to the dispensing unit.

The controller may take the money transported to the dispensing unit and then placed in the depositing unit into the apparatus to be recognized by the recognition unit.

The money recognized as money to be rejected is recognized again. This increases the probability that the money rejected due to transport anomaly, in particular, is recognized as normal money.

The controller may transport money recognized by the recognition unit as money to be rejected during the reconciliation process performed on the storage to the temporary storage.

The controller may perform, in the reconciliation process, primary transport of transporting the money from the storage to the other storage and secondary transport of transporting the money from the other storage to the storage. The controller may feed the money from the temporary storage and store the fed money in the storage after the end of the secondary transport.

This configuration can also empty the temporary storage after the reconciliation process ends.

The controller may feed the money from the temporary storage and transport the fed money to the dispensing unit after the end of the secondary transport.

This configuration can also empty the temporary storage after the reconciliation process ends.

The present disclosure relates to a money handling method. In this money handling method, money is recognized, money recognized as money to be rejected is stored in a storage, and the money stored in the storage is fed for another recognition, thereby performing a reconciliation process of accepting an inventory amount of the storage.

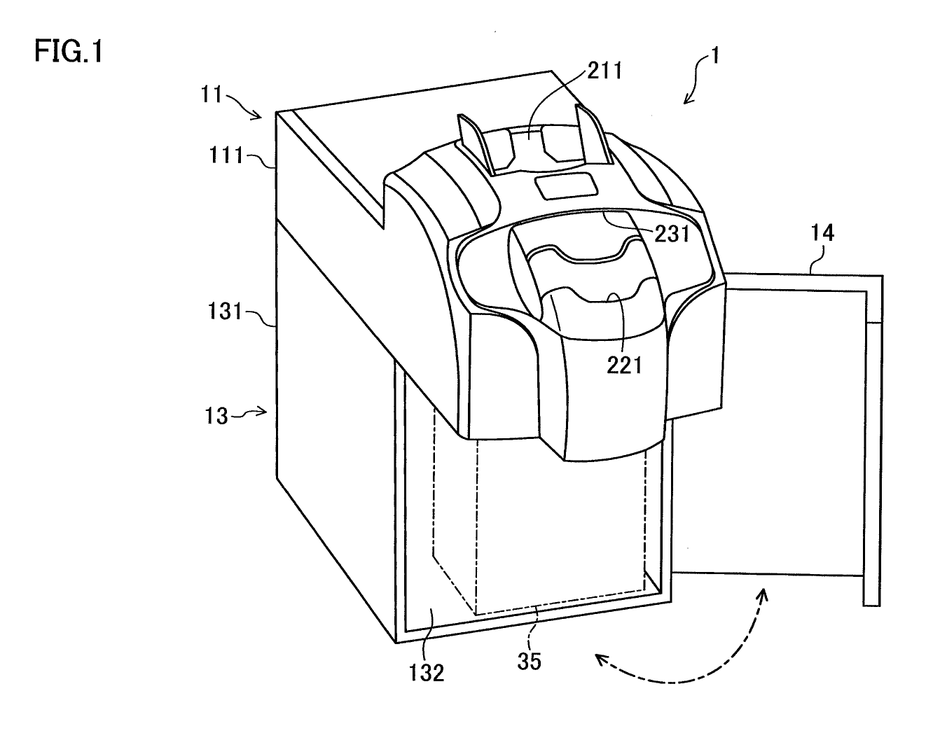

Embodiments of a money handling apparatus and a money handling method will be described below with reference to the drawings. Note that the following description is an example of the money handling apparatus. FIG. 1 shows a banknote handling apparatus 1 as an example of the money handling apparatus. The banknote handling apparatus 1 is installed in, e.g., branches of a bank or any other financial institutions, and performs various processes including a depositing process and a dispensing process. Note that, the banknote handling apparatus 1 may be installed in, for example, a back office of a retail store, in addition to a financial institution.

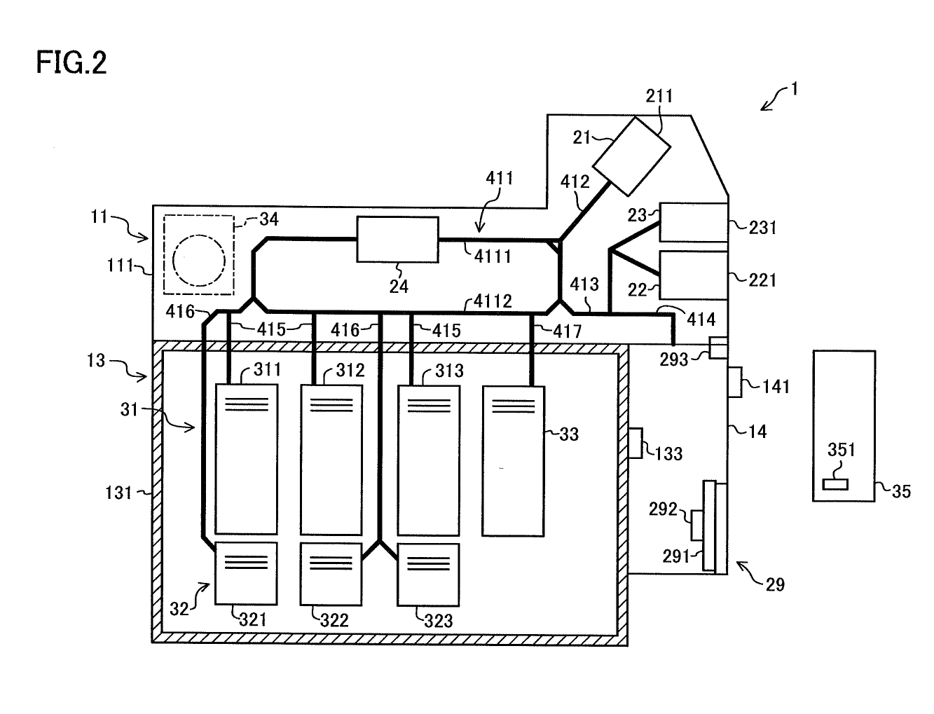

(General Configuration of Banknote Handling Apparatus) FIG. 1 shows an appearance of the banknote handling apparatus 1. FIG. 2 conceptually illustrates a configuration of the interior of the banknote handling device 1. In the following description, the right and left in the paper of FIG. 2 may be referred to as the “front” and “rear,” respectively. In other words, the “front” is the front on the right in the paper of FIG. 1, and the “rear” is the back on the left in the paper of FIG. 1.

The banknote handling apparatus 1 handles loose banknotes. The banknote handling apparatus 1 includes an upper handling unit 11 and a lower safe unit 13. In an upper housing 111 forming the handling unit 11, a depositing unit 21, a first dispensing unit 22, a second dispensing unit 23, a recognition unit 24, and part of a transport path are disposed.

The safe unit 13 includes a safe housing 131. A storage and part of the transport path are disposed in the safe housing 131. The safe housing 131 is configured to protect the storage at a security level equal to or higher than a predetermined level. The security level of the safe housing 131 is higher than that of the upper housing 111. As shown in FIG. 1, the safe housing 131 has a door 132 which is openable and closable on a front side thereof. The door 132 is provided with an electric lock 133, for example, as shown in FIG. 2. The door 132 opens when the electronic lock 133 is unlocked. Although not shown, the storage in the safe housing 131 can be drawn forward of the banknote handling apparatus 1 when the door 132 opens. A human who can unlock the electronic lock 133 of the safe housing 131, which is a safe, has a special authority. The door may be provided on the rear side of the safe housing 131. This configuration allows the storage housed in the safe housing 131 to be drawn rearward of the banknote handling apparatus 1.

The depositing unit 21 is a portion of the apparatus in which the banknotes are placed, for example, in a depositing process. The depositing unit 21 has an inlet 211. The inlet 211 opens toward the upper housing 111 at a front portion of the apparatus. The banknotes are placed in the depositing unit 21 via the inlet 211. The depositing unit 21 is configured to maintain a plurality of banknotes being stacked. The depositing unit 21 has a mechanism of taking the maintained banknotes one by one into the apparatus.

The first dispensing unit 22 is a portion of the apparatus to which the banknotes are transported, for example, in a dispensing process. The first dispensing unit 22 can be used for various applications. The first dispensing unit 22 is configured to maintain a plurality of banknotes being stacked. Specifically, a plurality of banknotes is stacked in the first dispensing unit 22. The first dispensing unit 22 has a larger capacity than the second dispensing unit 23 which will be described later. The first dispensing unit 22 has a first outlet 221. The first outlet 221 opens toward the upper housing 111 at a front portion of the apparatus. The banknotes stacked in the first dispensing unit 22 can be removed through the first outlet 221. A shutter which opens and closes may be provided for the first outlet 221.

The second dispensing unit 23 is a portion of the apparatus to which banknotes rejected, for example, in a depositing process, are transported. The second dispensing unit 23 can be used for various applications. Just like the first dispensing unit 22, the second dispensing unit 23 is also configured to maintain a plurality of banknotes being stacked. The second dispensing unit 23 has a smaller capacity than the first dispensing unit 22. The second dispensing unit 23 has a second outlet 231. The second outlet 231 opens toward the upper housing 111 at a front portion of the apparatus. The second outlet 231 is located above the first outlet 221. The banknotes stacked in the second dispensing unit 23 can be removed through the second outlet 231. A shutter which opens and closes may be provided for the second outlet 231.

The recognition unit 24 is provided at an upper path 4111 of a loop transport path 411 which will be described later. The recognition unit 24 recognizes at least a denomination of each banknote being transported through the upper path 4111, whether each banknote is genuine or not, and whether each banknote is fit or unfit.

The recognition unit 24 also recognizes transport anomaly of the banknotes. The “transport anomaly” means that the banknotes are not transported in a predetermined normal state, but skewed at a larger angle than a predetermined allowable angle with respect to the transport direction of the banknotes, or continuously transported at smaller intervals than allowable intervals.

The storage includes a large storage 31, a small storage 32, and a multi-purpose storage 33. The large storage 31, the small storage 32, and the multi-purpose storage 33 are all stacking storage cassettes each storing the banknotes stacked in the vertical direction. As described above, these storage cassettes can be detached from the safe housing 131 when they are drawn forward of the safe housing 131.

Any known configuration of the stacking storage cassette can be adopted. Note that each of the large storage 31, small storage 32, and multi-purpose storage 33 of the banknote handling apparatus 1 is able to take and store the banknotes therein, and feed the stored banknotes outside.

The large storage 31 has a relatively large capacity. In the illustrated example, the banknote handling apparatus 1 includes three large storages 31, namely, a first large storage 311, a second large storage 312, and a third large storage 313. The number of large storages 31 is not limited to three, and may be any suitable number.

The first to third large storages 311, 312, and 313 are located at a relatively upper portion inside the safe housing 131, and arranged side by side in a longitudinal direction of the banknote handling apparatus 1 (i.e., a horizontal direction in the paper of FIG. 2). The three large storages 31 store the banknotes sorted by denomination, for example.

The small storage 32 has a smaller capacity than the large storage 31. In the illustrated example, the banknote handling apparatus 1 includes three small storages 32, namely, a first small storage 321, a second small storage 322, and a third small storage 323. The number of small storages 32 is not limited to three, and may be any suitable number.

The first small storage 321 is disposed below the first large storage 311, the second small storage 322 is disposed below the second large storage 312, and the third small storage 323 is disposed below the third large storage 313. The first to third small storages 321 to 323 are also arranged side by side in the longitudinal direction of the banknote handling apparatus 1 (i.e., the horizontal direction in the paper of FIG. 2). The three small storages 32 store the banknotes sorted by denomination, for example.

The multi-purpose storage 33 has a larger capacity than the small storage 32. In the illustrated example, the banknote handling apparatus 1 includes a single multi-purpose storage 33. The banknote handling apparatus 1 may have two or more multi-purpose storages 33. The multi-purpose storage 33 is disposed in front of the third large storage 313.

The multi-purpose storage 33 stores banknotes that cannot be stored in the first to third large storages 311 to 313 and the first to third small storages 321 to 323. For example, the multi-purpose storage 33 may store overflowed banknotes, i.e., banknotes that cannot be stored any more in the first to third large storages 311 to 313 and the first to third small storages 321 to 323 because these storages are full or nearly full. For example, the multi-purpose storage 33 may store banknotes of an unspecified denomination, i.e., banknotes the denomination of which is not allocated to any of the first to third large storages 311 to 313 and the first to third small storages 321 to 323. The multi-purpose storage 33 may store unfit banknotes, for example. The multi-purpose storage 33 may store counterfeit banknotes, or banknotes suspected to be counterfeit, for example. As will be described later, the multi-purpose storage 33 may store banknotes rejected in a dispensing process. As will be described later, the multi-purpose storage 33 may store banknotes rejected in a reconciliation process.

Note that the storages in the safe housing 131 are not limited as to the number, configuration, and arrangement thereof.

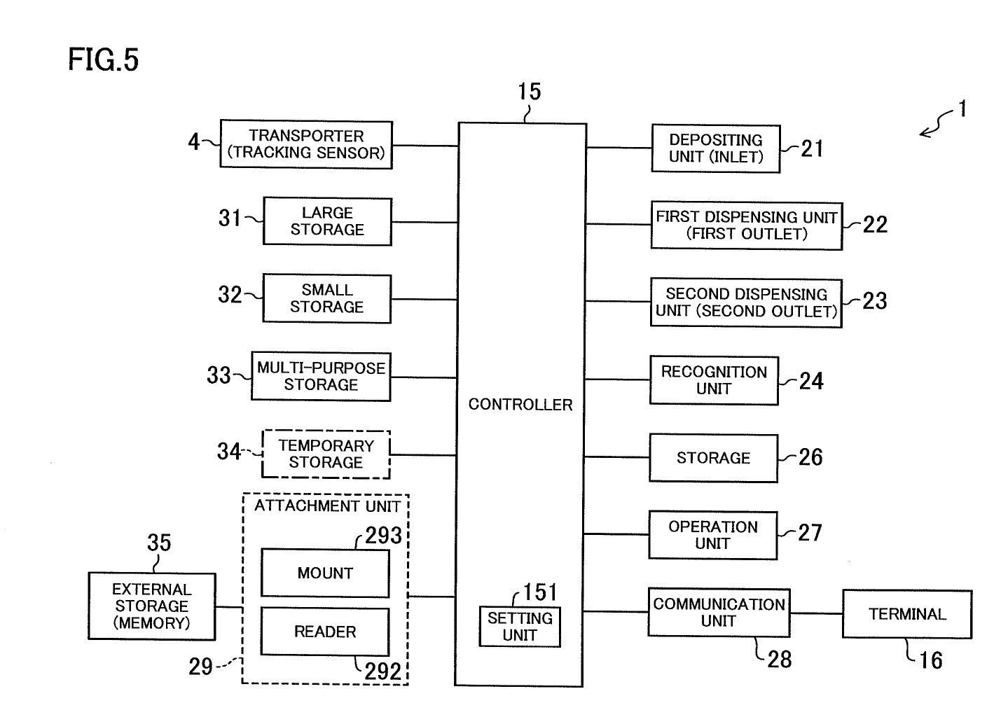

The transporter 4 (see FIG. 5) has a transport path. The transporter 4 transports the banknotes one by one at intervals along the transport path, for example, with a long edge of each banknote facing forward. The transporter 4 may transport the banknotes one by one at intervals along the transport path, for example, with a short edge of each banknote facing forward. Although not shown, the transport path is comprised of a combination of a plurality of rollers, a plurality of belts, a motor for driving the rollers, tracking sensors for detecting the banknotes transported, and a plurality of guides.

The transporter 4 has a loop transport path 411 provided in the upper housing 111. The loop transport path 411 is an endless path including an upper path 4111 extending in the longitudinal direction and connected to a lower path 4112 extending parallel to the upper path 4111. The upper path 4111 passes through the recognition unit 24. The lower path 4112 does not pass through the recognition unit 24. The transporter 4 transports the banknotes along the loop transport path 411 in the clockwise direction and the counterclockwise direction in FIG. 2.

The depositing unit 21 is connected to a front end of the loop transport path 411 via a connection path 412. The first and second dispensing units 22 and 23 are connected to the front end of the loop transport path 411 via a connection path 413. The connection path 413 is branched to be connected to the first and second dispensing units 22 and 23.

Each of the first to third large storages 311 to 313 is connected to the lower path 4112 of the loop transport path 411 via an associated one of connection paths 415. The three connection paths 415 extend in the vertical direction across the upper housing 111 and the safe housing 131, and are arranged side by side in the longitudinal direction.

Likewise, each of the first to third small storages 321 to 323 is connected to the lower path 4112 of the loop transport path 411 via an associated one of connection paths 416. One of the connection paths 416 extends in the vertical direction behind the first large storage 311, and the other connection path 416 extends in the vertical direction between the second and third large storages 312 and 313. The latter connection path 416 is branched to be connected to the second and third storages 322 and 323.

The multi-purpose storage 33 is connected to a portion of the loop transport path 411 adjacent to a front end of the lower path 4112 via a connection path 417.

Although not shown, a diverter which changes the destination of the banknotes is provided at a junction between the loop transport path 411 and each of the connection paths 412, 413, 415, 416, and 417. Further, diverters are respectively provided at a branch point of the connection path 413 and a branch point of the connection path 416.

A tracking sensor which detects the passage of the banknotes is provided for each of the loop transport path 411 and the connection paths 412, 413, 415, 416, and 417. Receiving a command from a controller 15 which will be described later, the transporter 4 controls the diverters of the transporter 4 based on the detection signals from the tracking sensors to transport each banknote to a predetermined destination.

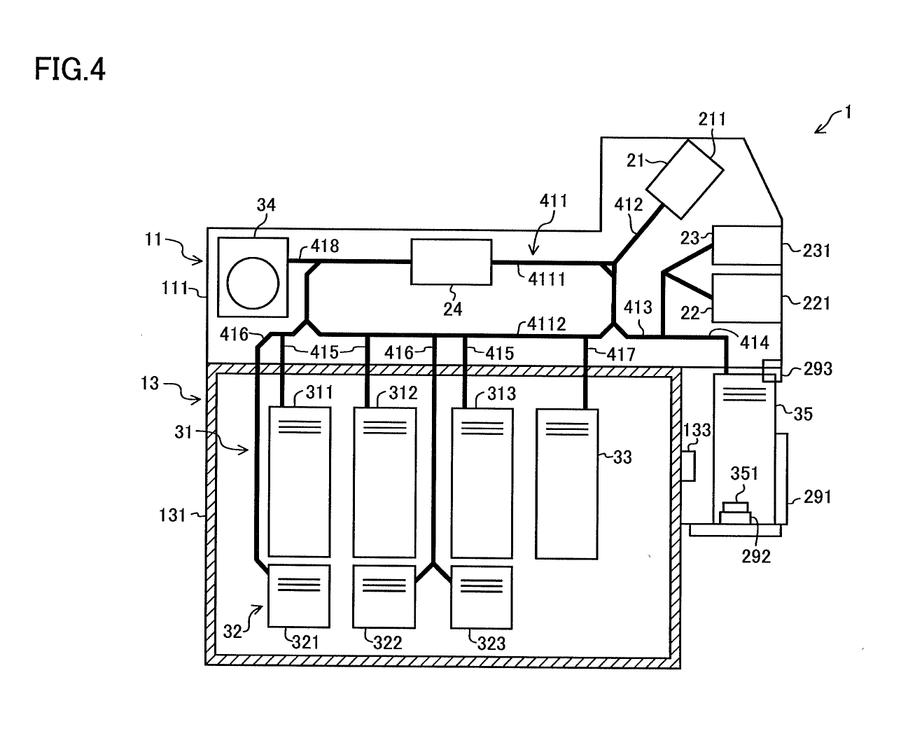

A temporary storage 34 can be provided in the upper housing 111 of the banknote handling apparatus 1. The temporary storage 34 is an optional component which is attachable to and detachable from the banknote handling apparatus 1. The banknote handling apparatus 1 may be configured without the temporary storage 34 as indicated by dashed lines in FIG. 2, or with the temporary storage 34 as indicated by solid lines in FIG. 4.

The temporary storage 34 temporarily stores banknotes to be deposited in the depositing process until the depositing process is confirmed, for example. The temporary storage 34 can be used for various applications as will be described later. Although not shown in detail, the temporary storage 34 is a winding storage. Any known configuration of the winding storage can be adopted. The temporary storage 34 is disposed in a rear portion in the inside of the upper housing 111. The temporary storage 34 is connected to a rear end of the upper path 4111 of the loop transport path 411 via a connection path 418.

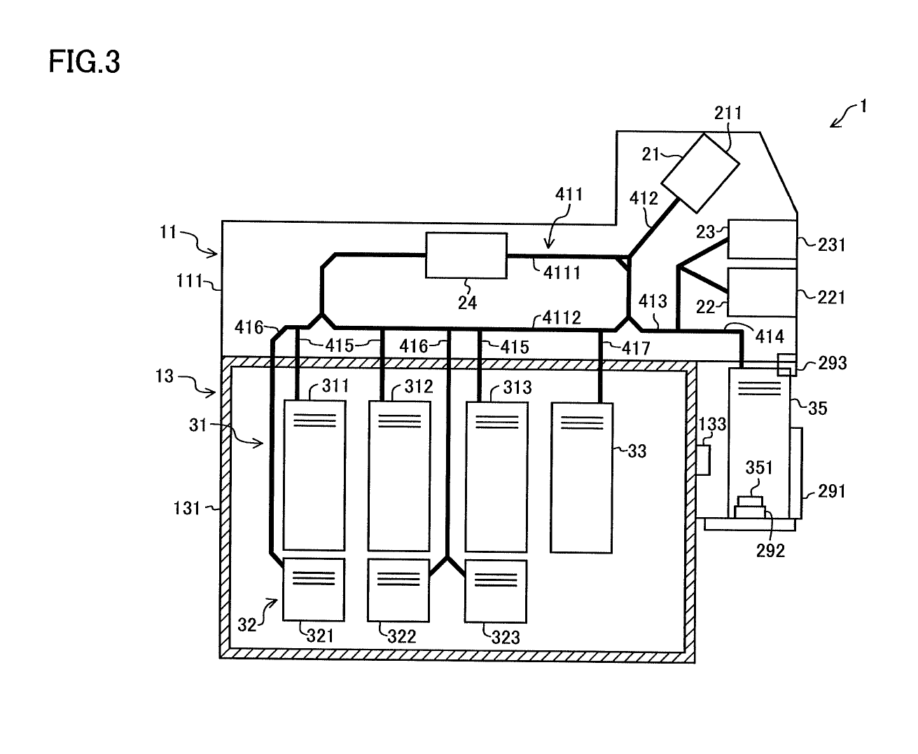

The banknote handling apparatus 1 has an external storage 35 disposed outside the safe housing as shown in FIGS. 2 and 3. The external storage 35 is attachable to and detachable from the body of the apparatus outside the safe housing 131. The external storage 35 is a removable storage.

The banknote handling apparatus 1 has an attachment unit 29 which allows the external storage 35 to be attached to the body of the apparatus. The attachment unit 29 has an attachment 291. The attachment 291 is foldable. As conceptually shown in FIG. 2, the attachment 291 is housed in the cover 14 in a folded state when not in use.

The cover 14 is attached to the body of the apparatus to cover the door 132 of the safe housing 131. The cover 14 is, for example, hinged to the body of the apparatus. The cover 14 is switchable between a state where the door 132 is covered as shown in FIG. 2, and a state where the door 132 is uncovered as shown in FIG. 1 (see a dashed line arrow in FIG. 1). When the cover 14 is closed, access to the electronic lock 133 of the door 132 is not allowed. The cover 14 has a lock 141 which is unlocked and locked, for example, by a key. The cover 14 opens when the lock 141 is unlocked. The key of the cover 14 cannot open the door 132.

The banknote handling apparatus 1 may include a detection unit which detects that the cover 14 has been unlocked. The banknote handling apparatus 1 may also include a notification unit that notifies a terminal 16 to be described later or any other means that the detection unit has detected the unlocking of the cover 14. This can further improve the security level of the money handling apparatus 1.

To attach the external storage 35 to the body of the apparatus, the cover 14 is opened to unfold the attachment 291. As shown in FIG. 3, the attachment 291, if unfolded, allows the external storage 35 to be attached to the body of the apparatus via the attachment 291. Note that the cover 14 is not shown in FIG. 3. When attached to the body of the apparatus, the external storage 35 is located on the front side of the door 132 as indicated by dashed lines in FIG. 1.

A mount 293 is provided for the body of the apparatus. Although not shown in detail, the mount 293 fixes the external storage 35 attached to the body of the apparatus. When manually operated by a human, the mount 293 is unlocked, and the external storage 35 can be detached from the body of the apparatus.

The external storage 35 has a memory 351. As will be described later, the memory 351 stores data about the banknotes stored in the external storage 35. The data about the banknotes includes, for example, data about the denomination of each banknote, data about the serial number of each banknote, and data about the number of banknotes stored in the external storage 35. The memory 351 stores the data about each banknote in association with the order of feeding the banknotes from the external storage 35, i.e., the storing order of the banknotes in the external storage 35. The memory 351 may store data about the total amount of the banknotes stored in the external storage 35.

The attachment 291 is provided with a reader 292 which reads the data from the memory 351. When the external storage 35 is attached to the body of the apparatus via the attachment 291, the reader 292 is electrically connected to the memory 351 to be able to read the data from the memory 351. The reader 292 may be provided for any other part of the apparatus except for the attachment 291. The reader 292 may be provided for the body of the banknote handling apparatus 1, for example, the safe housing 131. Alternatively, the reader 292 may be provided for the upper housing 111. The reader 292 may read the data from the memory 351 with no contact with the memory 351.

When attached to the body of the apparatus, the external storage 35 is connected to the loop transport path 411 via the connection paths 414 and 413 as shown in FIG. 4. That is, the connection path 414 is branched from the connection path 413.

The cover 14 may be closable with the external storage 35 attached to the body of the apparatus. This configuration allows the cover 14 to cover the external storage 35. Alternatively, the cover 14 may not be closable with the external storage 35 attached to the body of the apparatus.

When closed, the cover 14 conceals the reader 292. Nobody can touch the reader 292. This can prevent unauthorized access to the reader 292, e.g., unauthorized reading of data by the reader 292.

FIG. 5 is a block diagram illustrating a configuration of the banknote handling apparatus 1. The banknote handling apparatus 1 includes a controller 15 as the control unit. The controller 15 is connected to the depositing unit 21, the first dispensing unit 22, the second dispensing unit 23, the recognition unit 24, the transporter 4, the large storage 31, the small storage 32, the multi-purpose storage 33, and the attachment unit 29 so that the controller 15 can transmit and receive signals to and from these units. The mount 293 of the attachment unit 29 outputs a signal while the external storage 35 is attached to the body of the apparatus. Once the external storage 35 is detached from the body of the apparatus, the mount 293 no longer outputs the signal. Based on the signal from the mount 293, the controller 15 can determine whether the external storage 35 has been attached to or detached from the body of the apparatus.

When attached, the temporary storage 34, which is an optional component, is also connected to the controller 15 to be able to transmit and receive signals to and from the controller 15. The controller 15 can determine whether the temporary storage 34 has been attached to or detached from the body of the apparatus.

The banknote handling apparatus 1 includes storage 26 which stores various data, an operation unit 27 that is operated by a human, and a communication unit 28 which communicates with a terminal 16. The storage 26, the operation unit 27, and the communication unit 28 are also connected to the controller 15 to be able to transmit and receive signals to and from the controller 15. The operation unit 27 may be, for example, a touch panel display.

A human operates the terminal 16 to perform various services using the banknote handling apparatus 1.

The controller 15 controls the depositing unit 21, the first and second dispensing units 22 and 23, the recognition unit 24, the transporter 4, the large storage 31, the small storage 32, the multi-purpose storage 33, and the temporary storage 34 when a human operates the operation unit 27 or the terminal 16.

The controller 15 includes a setting unit 151. The setting unit 151 sets the specific condition for the transport of the banknotes. The specific condition will be described in detail later.

It will be described below how the banknote handling apparatus 1 performs various processes with reference to the drawings.

### (Depositing Process)

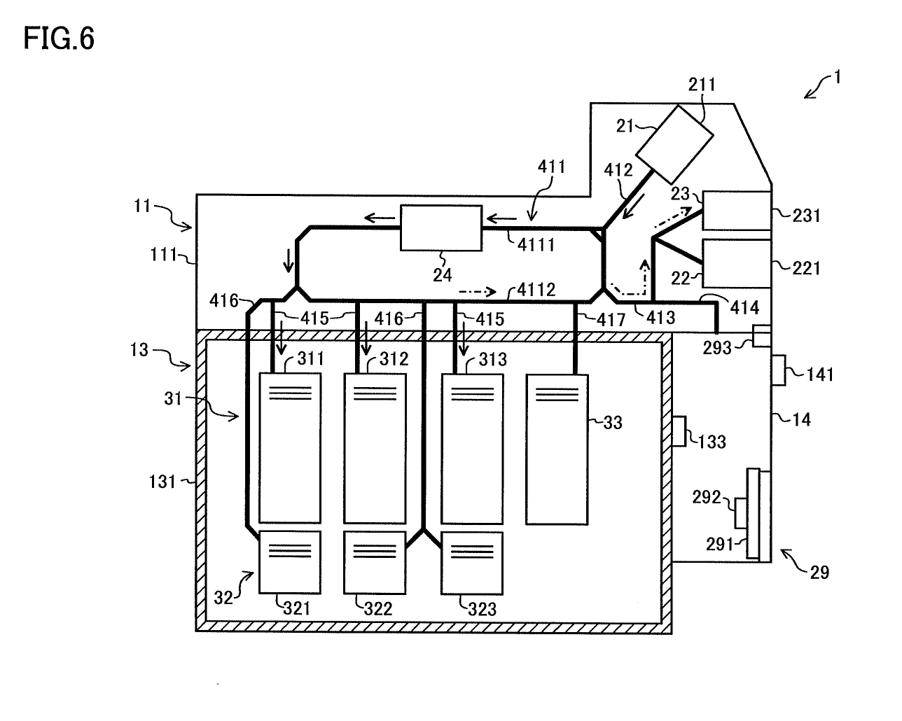

FIG. 6 shows an example of how the banknotes travel in the banknote handling apparatus 1 during the depositing process. FIG. 6 particularly shows an example of how the banknotes to be deposited are stored in the large storage 31.

The banknotes to be deposited are placed in the depositing unit 21. The depositing unit 21 takes the banknotes one by one into the apparatus. As indicated by solid line arrows in FIG. 6, the transporter 4 transports the banknotes to the recognition unit 24 through the connection path 412 and the upper path 4111 of the loop transport path 411. The recognition unit 24 recognizes the banknotes. As indicated by the solid line arrows, the transporter 4 transports the banknotes that have passed through the recognition unit 24 toward the large storages 31 through the connection path 415. The banknotes are stored in an associated one of the large storages 31 in accordance with the result of the recognition.

As indicated by dashed line arrows, the transporter 4 transports banknotes recognized as banknotes to be rejected by the recognition unit 24 to the second dispensing unit 23 through the lower path 4112 of the loop transport path 411 and the connection path 413. As described above, the rejected banknotes include banknotes rejected due to transport anomaly. After all the banknotes to be deposited are taken into the apparatus through the dispensing unit 21, the banknotes dispensed to the second dispensing unit 23 are manually placed again in the depositing unit 21. The banknotes placed again in the depositing unit 21 are taken into the apparatus once more.

When all the banknotes placed in the depositing unit 21 are taken into the apparatus, the amount of the banknotes deposited is displayed on the terminal 16, for example. The depositing process ends when a human operates the terminal 16 or the operation unit 27 to confirm the depositing process. The controller 15 stores and manages data about the banknotes stored in the large storage 31 in the storage 26.

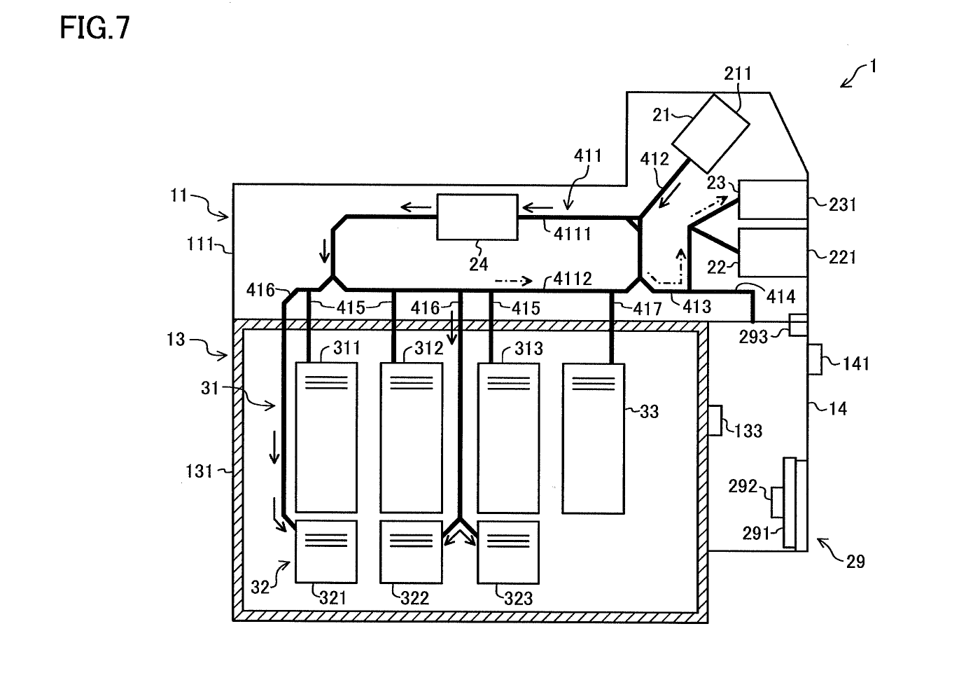

FIG. 7 shows an example of how the banknotes travel in the banknote handling apparatus 1 during the depositing process. FIG. 7 particularly shows how the banknotes to be deposited are stored in the small storage 32.

As described above, the depositing unit 21 takes the banknotes placed therein into the apparatus one by one. As indicated by solid line arrows in FIG. 7, the transporter 4 transports the banknotes to the recognition unit 24 through the connection path 412 and the upper path 4111 of the loop transport path 411. The recognition unit 24 recognizes the banknotes. As indicated by solid line arrows, the transporter 4 transports the banknotes that have passed through the recognition unit 24 to the small storages 32 through the connection path 416. The banknotes are stored in an associated one of the small storages 32 in accordance with the result of the recognition.

As indicated by dashed line arrows, the transporter 4 transports the rejected banknotes to the second dispensing unit 23 through the lower path 4112 of the loop transport path 411 and the connection path 413. The banknotes dispensed to the second dispensing unit 23 are manually placed again in the depositing unit 21 and taken into the apparatus once more as described above.

The depositing process ends when all the banknotes placed in the depositing unit 21 are taken into the apparatus, and the depositing process is confirmed by a human's operation. Likewise, the controller 15 stores and manages data about the banknotes stored in the small storage 32 in the storage 26.

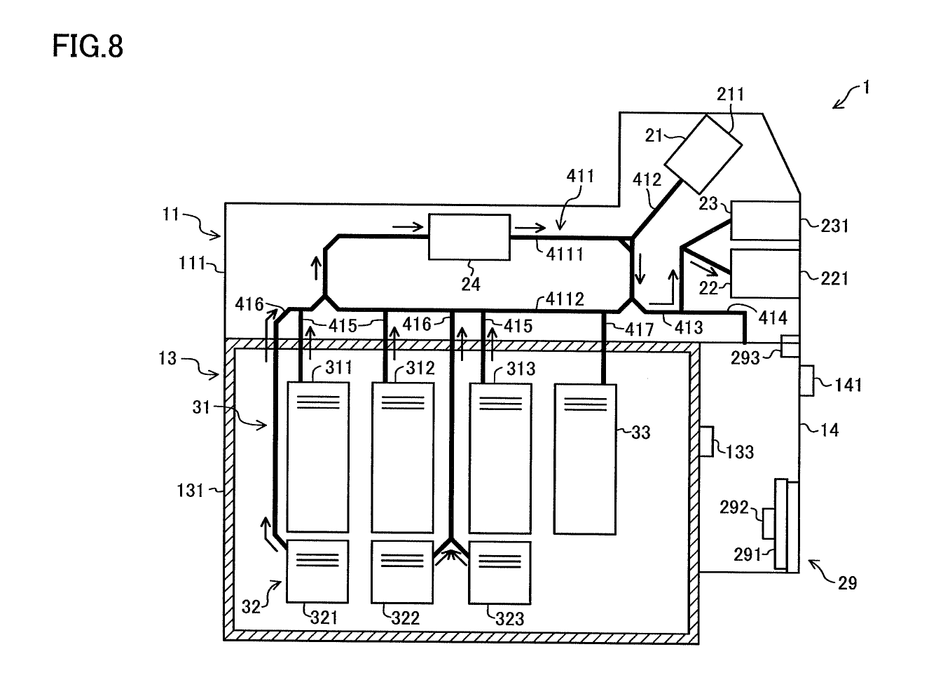

As described above, FIG. 8 shows an example of how the banknotes travel in the apparatus when the terminal 16 shows the amount of the deposited banknotes and a human operates the terminal 16 or the operation unit 27 to cancel the deposit. When the deposit is cancelled, the banknotes once stored in the large or small storage 31 or 32 are fed from the large or small storage 31 or 32, as described above. As indicated by solid line arrows in FIG. 8, the transporter 4 transports the banknotes to the first dispensing unit 22 through the connection path 415 or 416, the upper path 4111 of the loop transport path 411, and the connection path 413. The recognition unit 24 recognizes the banknotes being transported to the first dispensing unit 22. Thus, the banknotes to be deposited are returned.

### (Dispensing Process)

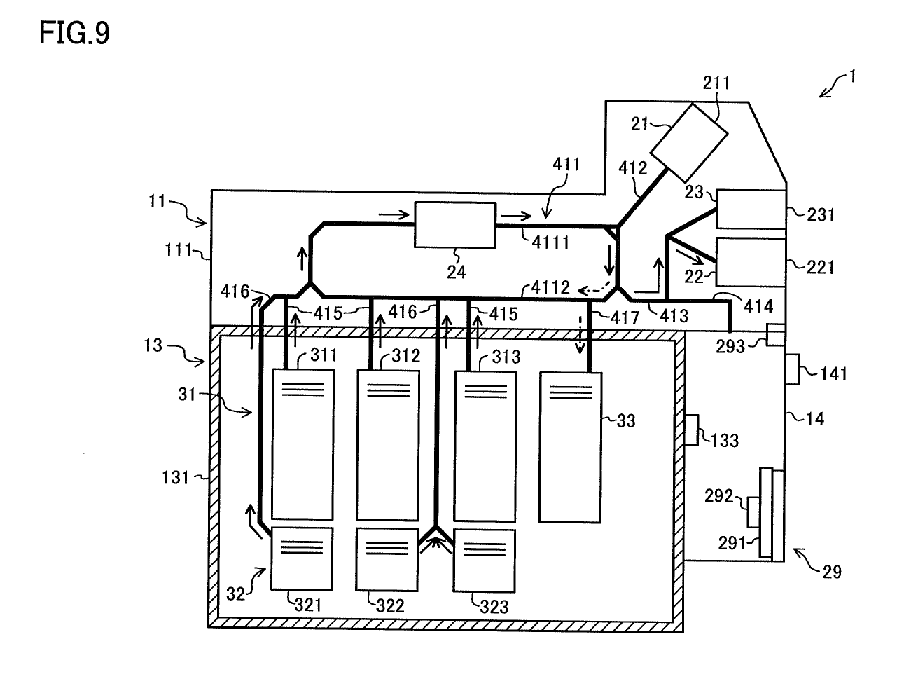

FIG. 9 shows an example of how the banknotes travel in the banknote handling apparatus 1 during the dispensing process. The large or small storage 31 or 32 feeds the banknotes to be dispensed. The transporter 4 transports the banknotes to the recognition unit 24 through the connection path 415 or 416 and the loop transport path 411. The recognition unit 24 recognizes the banknotes. The transporter 4 transports the recognized banknotes to the first dispensing unit 22 through the loop transport path 411 and the connection path 413.

If some banknotes are recognized by the recognition unit 24 as banknotes to be rejected, the transporter 4 transports the rejected banknotes to the multi-purpose storage 33 through the lower path 4112 of the loop transport path 411 and the connection path 417 as indicated by dashed line arrows in FIG. 9. The banknotes rejected in the dispensing process include banknotes rejected due to transport anomaly described above, and banknotes whose denomination is different from the denomination of the banknotes to be stored in the storage.

The multi-purpose storage 33 stores banknotes rejected in the dispensing process. The dispensing process ends when all the banknotes to be dispensed are dispensed to the first dispensing unit 22. The controller 15 deletes data about the banknotes fed from the large or small storage 31 or 32 from the storage 26.

### (Replenishment Process)

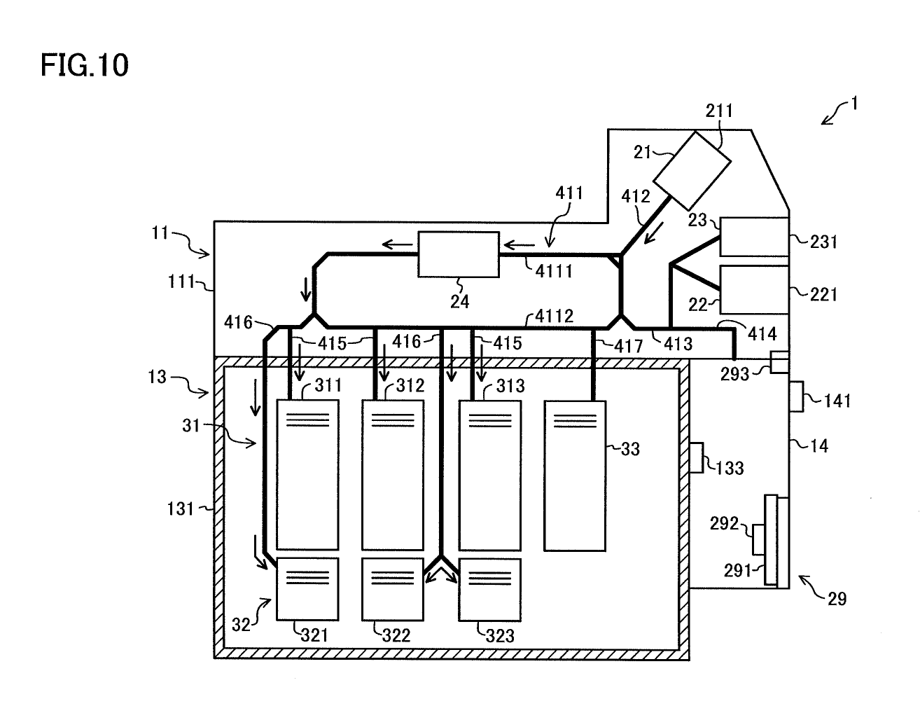

FIG. 10 shows an example of how the banknotes travel in the banknote handling apparatus 1 during the replenishment process. FIG. 10 particularly shows how the banknotes for replenishing the storage travel after being placed in the depositing unit 21.

In the replenishment process using the depositing unit 21, the banknotes travel in the same manner as in the depositing process described above. Specifically, the depositing unit 21 takes the banknotes for replenishment one by one into the apparatus. As indicated by solid line arrows in FIG. 10, the transporter 4 transports the banknotes to the recognition unit 24 through the connection path 412 and the upper path 4111 of the loop transport path 411. The recognition unit 24 recognizes the banknotes. As indicated by the solid line arrows, the transporter 4 transports the banknotes that have passed through the recognition unit 24 to the large or small storage 31 or 32 through the connection path 415 or 416. The large or small storage 31 or 32 stores the banknotes. The replenishment process ends when all the banknotes for replenishment placed in the depositing unit 21 are stored in the large or small storage 31 or 32. The controller 15 stores and manages data about the banknotes stored in the large or small storage 31 or 32 in the storage 26.

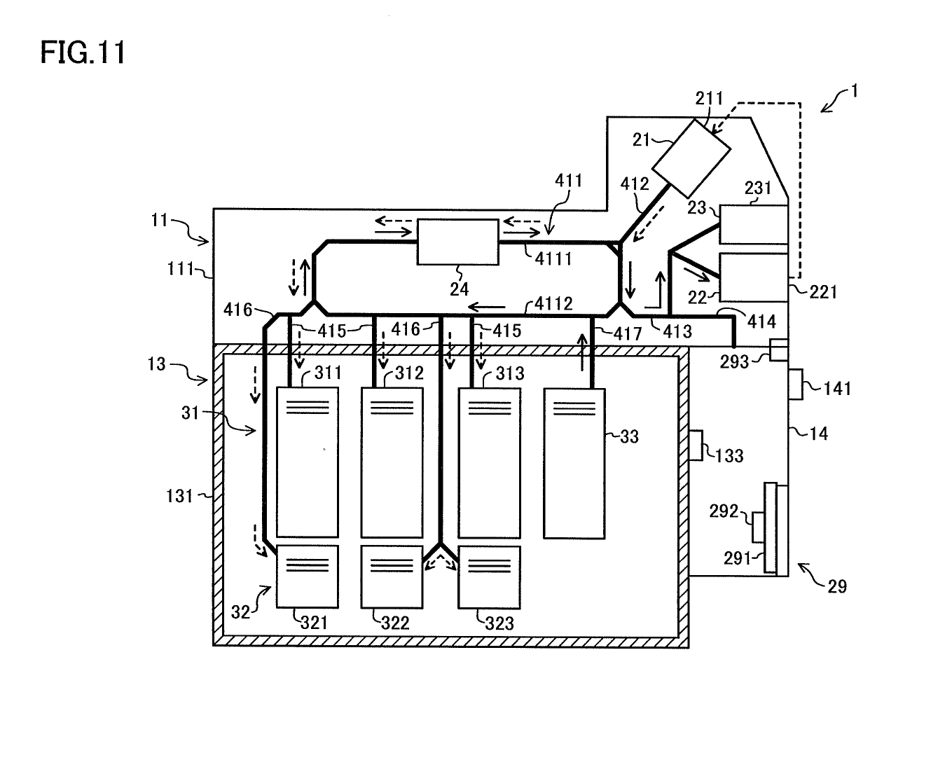

FIG. 11 shows an example of how the banknotes stored in the multi-purpose storage 33 are taken into the apparatus as the banknotes for replenishment. As indicated by solid line arrows in FIG. 11, the multi-purpose storage 33 feeds the banknotes. The transporter 4 transports the banknotes to the recognition unit 24 through the lower path 4112 and upper path 4111 of the loop transport path 411. The banknotes travel along the loop transport path 411 in the clockwise direction in FIG. 11. The transporter 4 transports the banknotes that have been recognized by the recognition unit 24 to the first dispensing unit 22 through the connection path 413 as indicated by the solid line arrows.

The banknotes dispensed to the first dispensing unit 22 are manually removed and placed again in the depositing unit 21 (see the dashed line arrows in FIG. 11). Subsequent operations of the banknote handling apparatus 1 are the same as those in the replenishment process shown in FIG. 10. Specifically, the depositing unit 21 takes the banknotes into the apparatus one by one, and the transporter 4 transports the banknotes to the recognition unit 24 through the upper path 4111 as indicated by the dashed line arrows in FIG. 11. The transporter 4 transports the banknotes that have passed through the recognition unit 24 to the large or small storage 31 or 32 through the connection path 415 or 416 as indicated by the dashed line arrows. The large or small storage 31 or 32 stores the banknotes. The replenishment process ends when all the banknotes for replenishment placed in the depositing unit 21 are stored in the large or small storage 31 or 32.

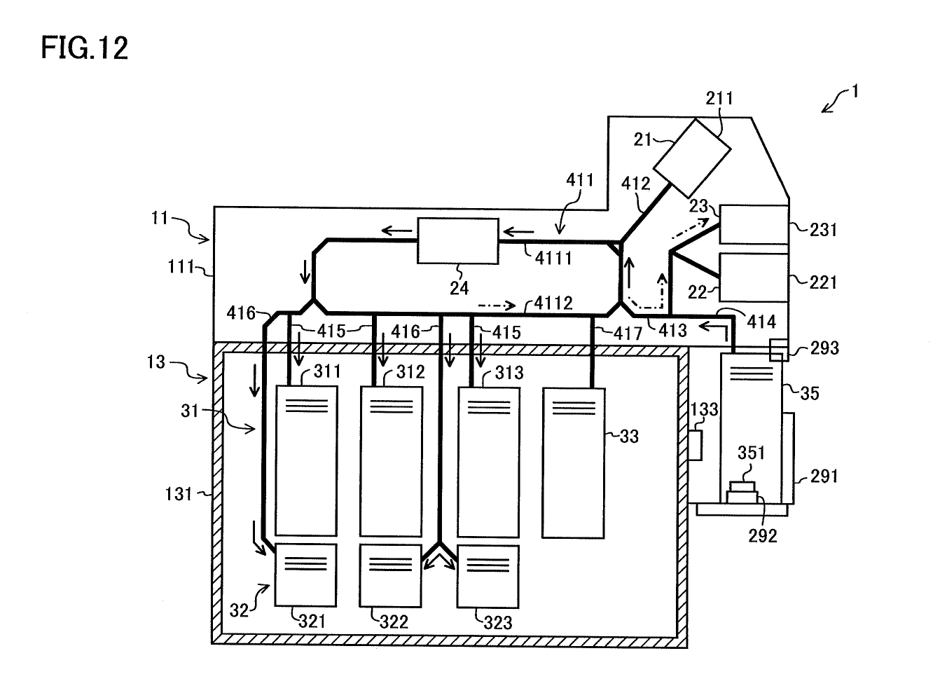

FIG. 12 shows an example of how the banknotes travel in the banknote handling apparatus 1 during the replenishment process using the external storage 35. In this case, the external storage 35 stores the banknotes for replenishment. The apparatus can start the replenishment process when the external storage 35 is attached to the body of the apparatus. The controller 15 determines whether the external storage 35 is attached to the body of the apparatus or not based on the signal from the mount 293. The controller 15 does not start the replenishment process if the external storage 35 is not attached to the body of the apparatus.

When the replenishment process starts, the external storage 35 feeds the banknotes as indicated by solid line arrows in FIG. 12. The transporter 4 transports the banknotes to the recognition unit 24 through the connection paths 414 and 413 and the upper path 4111 of the loop transport path 411. The recognition unit 24 recognizes the banknotes.

The transporter 4 allows the banknotes to pass through the connection path 415 or 416 to store them in the large or small storage 31 or 32 in accordance with the result of the recognition (see the solid line arrows). The large or small storage 31 or 32 stores the banknotes. The controller 15 stores and manages data about the banknotes stored in the large or small storage 31 or 32 in the storage 26.

The external storage 35 has a memory 351. The memory 351 stores data about the banknotes stored in the external storage 35. The data about the banknotes includes, for example, data of the denomination of each banknote, data of the serial number of each banknote, and data of the number of banknotes stored in the external storage 35. If the reader 292 has read the data stored in the memory 351, the recognition unit 24 does not need to acquire the data about the banknotes stored in the external storage 35 in the replenishment process.

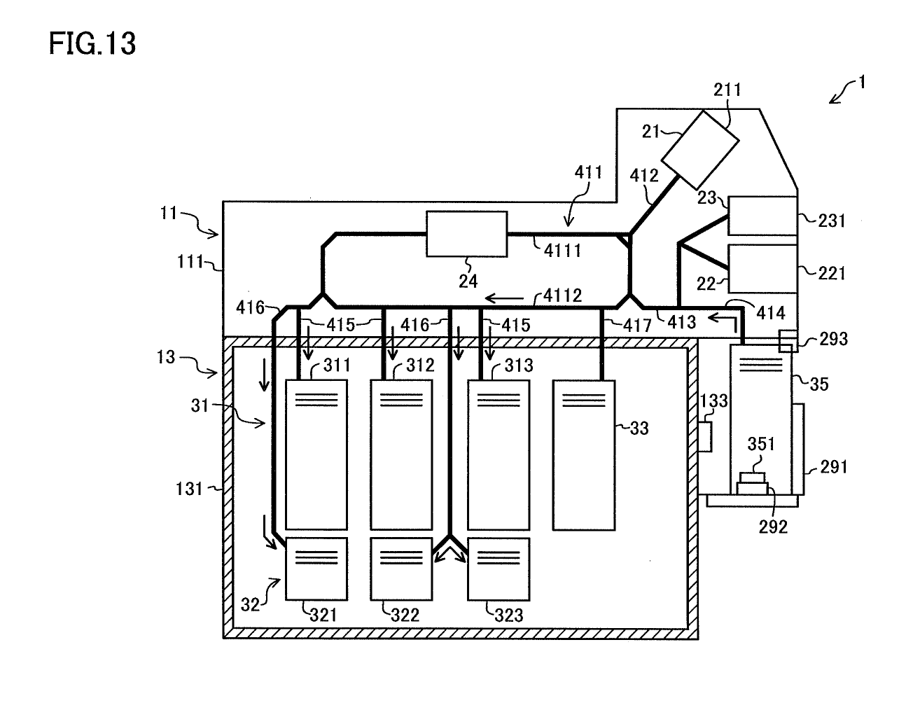

Thus, if the reader 292 has read the data about the banknotes from the memory 351, the controller 15 skips the recognition by the recognition unit 24 in the replenishment process using the external storage 35. FIG. 13 shows an example of how the banknotes travel in the replenishment process which skips the recognition by the recognition unit 24.

Specifically, when the replenishment process starts, the transporter 4 transports the banknotes fed from the external storage 35 to the lower path 4112 of the loop transport path 411 through the connection paths 414 and 413 as indicated by solid line arrows in FIG. 13. The transporter 4 transports the banknotes to the large or small storage 31 or 32 through the connection path 415 or 416 in accordance with the data about the banknotes acquired from the memory 351. The large or small storage 31 or 32 stores the banknotes. The controller 15 stores the data about the banknotes acquired from the memory 351 in the storage 26 in association with the information about the storage storing the banknotes.

The banknote handling apparatus 1 is configured to select either a route that passes through the recognition unit 24 (i.e., a first route including the upper path 4111) or a route that does not pass through the recognition unit 24 (i.e., a second route including the lower path 4112) when performing the replenishment process using the external storage 35.

If the route that passes through the recognition unit 24 is selected, the replenishment process can be performed accurately in accordance with the result of the recognition of each banknote.

If the route that does not pass through the recognition unit 24 is selected, the recognition of each banknote is skipped, which shortens time required for the replenishment process. The recognition unit 24 is disposed on the upper path 4111 of the loop transport path 411, and the large and small storages 31 and 32 are connected to the lower path 4112 of the loop transport path 411 via the connection paths 415 and 416. In a route for transporting the banknotes between the external storage 35 and the large or small storage 31 or 32, the second route that does not pass through the recognition unit 24 is shorter than the first route that passes through the recognition unit 24. Therefore, selecting the second route that does not pass through the recognition unit 24 can further shorten the time required for the replenishment process.

The banknote handling apparatus 1 can change the route for transporting the banknotes in the replenishment process, which makes the apparatus more convenient. Specifically, when performing the replenishment process, the banknote handling apparatus 1 can select the route for transporting the banknotes from the first route that passes through the recognition unit 24 and the second route that does not pass through the recognition unit 24 in accordance with the specific condition, i.e., whether the data about the banknotes for replenishment has been acquired or not.

Instead of acquiring the data about the banknotes for replenishment from the memory 351 of the external storage 35, the banknote handling apparatus 1 may receive the data, externally entered, about the banknotes for replenishment. For example, the data about the banknotes for replenishment may be entered to the banknote handling apparatus 1 through the terminal 16. The controller 15 of the banknote handling apparatus 1 may select the route that does not pass through the recognition unit 24 as shown in FIG. 13 if the data about the banknotes for replenishment is acquired in the replenishment process using the external storage 35, irrespective of whether the data is acquired from the memory 351 or not.

The route for transporting the banknotes may be arbitrarily selected by a human operating the operation unit 27 or the terminal 16, instead of changing the route for transporting the banknotes based on whether the data about the banknotes for replenishment has been acquired or not. Specifically, when performing the replenishment process, the banknote handling apparatus 1 can select either the first route that passes through the recognition unit 24 or the second route that does not pass through the recognition unit 24 in accordance with the specific condition which is manual operation.

Banknotes rejected in the replenishment process using the external storage 35 are dispensed to the second dispensing unit 23 as indicated by dash line arrows in FIG. 12. Specifically, the transporter 4 transports the rejected banknotes to the second dispensing unit 23 through the lower path 4112 of the loop transport path 411 and the connection path 413. The rejected banknotes include banknotes rejected due to transport anomaly.

The route for transporting the rejected banknotes, i.e., the route from the recognition unit 24 to the second dispensing unit 23, intersects with part of the route from the external storage 35 to the recognition unit 24. Therefore, when some banknotes are rejected, the controller 15 stops the feeding of the banknotes from the external storage 35. When the rejected banknotes are transported to the second dispensing unit 23, the controller 15 resumes the feeding of the banknotes from the external storage 35. If the rejected banknotes are preferentially transported to the second dispensing unit 23, the banknotes for replenishment and the rejected banknotes do not collide with each other at the junction. Thus, the replenishment process using the external storage 35 can smoothly proceed.

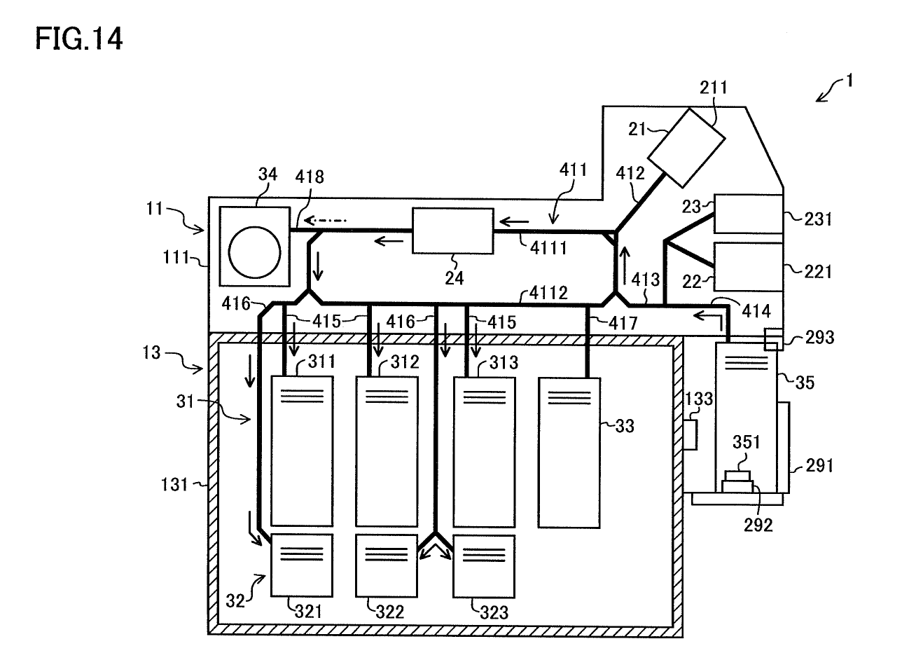

FIG. 14 shows an example of how the banknotes travel in the replenishment process using the external storage 35 and the temporary storage 34. In this replenishment process, the temporary storage 34 temporarily stores banknotes recognized by the recognition unit 24 as banknotes to be rejected.

Specifically, when the replenishment process starts, the transporter 4 transports the banknotes fed from the external storage 35 to the recognition unit 24 through the connection paths 414 and 413 and the upper path 4111 as indicated by solid line arrows in FIG. 14. The recognition unit 24 recognizes the banknotes. The transporter 4 transports the banknotes recognized as normal banknotes (those not recognized as banknotes to be rejected) to the large or small storage 31 or 32 through the connection path 415 or 416 as described above. The large or small storage 31 or 32 stores the banknotes. The transporter 4 transports the banknotes recognized by the recognition unit 24 as banknotes to be rejected to the temporary storage 34 through the connection path 418. The temporary storage 34 stores the rejected banknotes.

The temporary storage 34 is disposed in the middle of the route from the recognition unit 24 to the large or small storage 31 or 32. Since the temporary storage 34 stores the rejected banknotes, there is no need to stop the feeding of the banknotes from the external storage 35 even if some banknotes are rejected, unlike in the example shown in FIG. 12. Use of the temporary storage 34 can make the replenishment process using the external storage 35 more smooth.

When the replenishment process ends, the temporary storage 34 feeds the rejected banknotes stored during the replenishment process. This can empty the temporary storage 34.

Although not shown, the transporter 4 may transport the rejected banknotes fed from the temporary storage 34 to the second dispensing unit 23 through the loop transport path 411 and the connection path 413.

Further, although not shown, the transporter 4 may transport the rejected banknotes fed from the temporary storage 34 to the recognition unit 24 for second recognition. The transporter 4 may transport banknotes not recognized as banknotes to be rejected in the second recognition to the large or small storage 31 or 32 through the lower path 4112 and the connection path 415 or 416. This can reduce the number of banknotes rejected in the replenishment process. The transporter 4 may transport the banknotes recognized as banknotes to be rejected in the second recognition to the second dispensing unit 23 through the loop transport path 411 and the connection path 413 as described above.

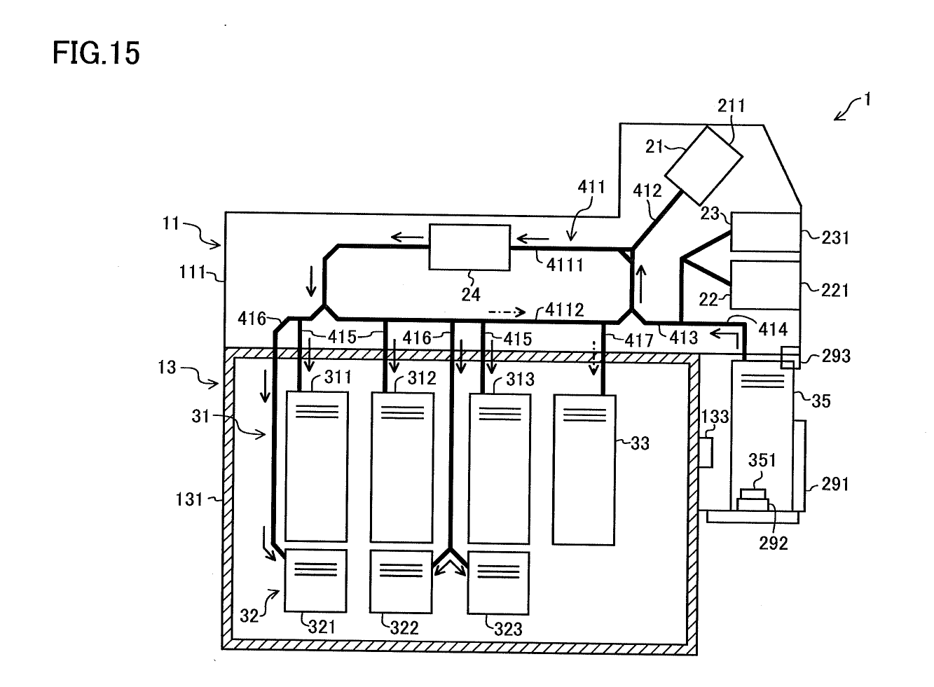

FIG. 15 shows, just like FIG. 12, an example of how the banknote handling apparatus 1 having no temporary storage 34 performs a smooth replenishment process. In the example shown in FIG. 15, the transporter 4 transports the banknotes rejected in the replenishment process, not to the second dispensing unit 23, but to the multi-purpose storage 33. The multi-purpose storage 33 stores the rejected banknotes.

Specifically, when the replenishment process starts, the transporter 4 transports the banknotes fed from the external storage 35 to the recognition unit 24 through the connection paths 414 and 413 and the upper path 4111 of the loop transport path 411 as indicated by solid line arrows in FIG. 15. Then, the transporter 4 transports the banknotes recognized as normal banknotes by the recognition unit 24 to the large or small storage 31 or 32 through the connection path 415 or 416. The large or small storage 31 or 32 stores the banknotes. The transporter 4 transports the banknotes recognized by the recognition unit 24 as banknotes to be rejected to the multi-purpose storage 33 through the lower path 4112 and the connection path 417. The multi-purpose storage 33 stores the rejected banknotes.

Since the multi-purpose storage 33 stores the rejected banknotes, there is no need to stop the feeding of the banknotes from the external storage 35 even if some banknotes are rejected. Accordingly, the replenishment process using the external storage 35 can proceed smoothly.

The multi-purpose storage 33 stores the rejected banknotes, and thus, the rejected banknotes are accumulated in the safe. This can improve the security level of the banknote handling apparatus 1.

### (Collection Process)

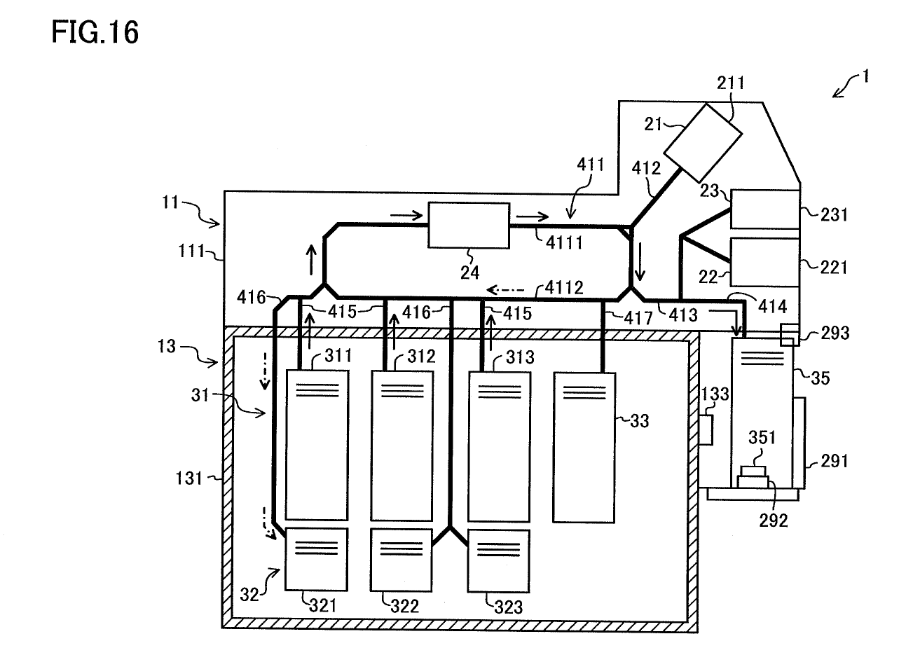

FIG. 16 shows an example of how the banknotes travel in a collection process using the external storage 35. FIG. 16 particularly shows how the banknotes in the large storage 31 are collected into the external storage 35. Note that the banknotes collected from the small storage 32 into the external storage 35 travel substantially in the same manner as shown in FIG. 16.

The collection process can start when the external storage 35 is attached to the body of the apparatus. When the collection process starts, the large storage 31, from which the banknotes are to be collected, feeds the banknotes as indicated by solid line arrows in FIG. 16. The transporter 4 transports the banknotes to the recognition unit 24 through the connection path 415 and the loop transport path 411. The recognition unit 24 recognizes the banknotes. As indicated by the solid line arrows, the transporter 4 transports banknotes recognized as normal banknotes to the external storage 35 through the connection paths 413 and 414. The external storage 35 stores the banknotes. The collection process ends when a designated number of banknotes are stored in the external storage 35.

The data about the banknotes acquired through the recognition by the recognition unit 24 is managed in association with the external storage 35. The controller 15 deletes the data about the banknotes to be collected from the storage 26. The external storage 35 is detached from the body of the apparatus.

In the example shown in FIG. 16, the banknotes rejected during the collection process are stored in the first small storage 321 as indicated by the dash line arrows. In this example, part of the route from the large storage 31 (in particular, the first large storage 311) to the recognition unit 24 intersects with the route from the recognition unit 24 to the first small storage 321. Thus, the controller 15 temporarily stops the feeding of the banknotes from the first large storage 311 until the rejected banknotes are transported to the first small storage 321. When the rejected banknotes are transported to the first small storage 321, the controller 15 resumes the feeding of the banknotes from the first large storage 311.

As described above, in the route between the external storage 35 and the large or small storage 31 or 32, the first route that passes through the recognition unit 24 is longer than the second route that does not pass through the recognition unit 24. When the recognition unit 24 performs the recognition, time required for the collection process correspondingly becomes longer.

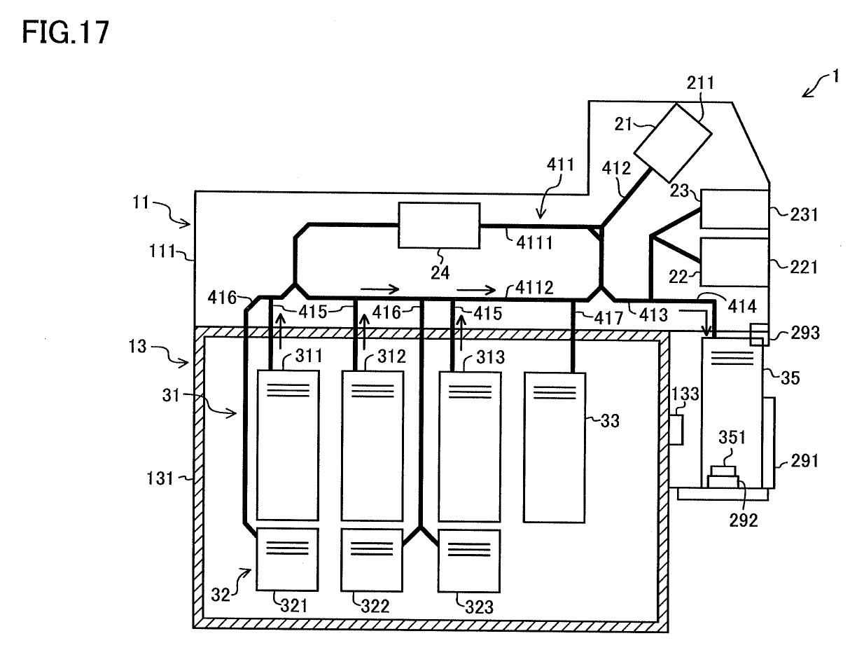

Therefore, in order to shorten the time required for the collection process, the banknote handling apparatus 1 can perform two kinds of collection processes using the external storage 35, namely, a first collection process shown in FIG. 16 and a second collection process shown in FIG. 17. FIG. 17 shows an example of how the banknotes travel during the second collection process performed by the banknote handling apparatus 1.

Specifically, when the second collection process starts, the large storage 31, from which the banknotes are to be collected, feeds the banknotes as indicated by solid line arrows in FIG. 17. The transporter 4 transports the banknotes to the external storage 35 through the connection path 415, the lower path 4112, and the connection paths 413 and 414. The external storage 35 stores the banknotes.

The second collection process using the shorter second route can shorten the time required for transporting the banknotes. Since the recognition by the recognition unit 24 is skipped, the time for the collection process can further be shortened.

FIG. 17 shows the process of collecting the banknotes from the large storage 31. Note that the banknotes travel substantially in the same manner as the banknotes collected from the small storage 32.

The banknote handling apparatus 1 (i.e., the controller 15) may select either the first collection process shown in FIG. 16 or the second collection process shown in FIG. 17 in accordance with the manual operation of the operation unit 27 or the terminal 16.

The controller 15 may automatically select the first collection process or the second collection process in accordance with a predetermined specific condition.

Specifically, in collecting a designated number of banknotes from the large or small storage 31 or 32, i.e., in collecting only some banknotes from the large or small storage 31 or 32, the number of the banknotes to be collected is relatively small. Thus, the time required for the collection process can be shortened. In this case, the controller 15 selects the first collection process using the route through which the banknotes pass through the recognition unit 24 as shown in FIG. 16. The recognition unit 24 counts the designated number of banknotes.

In collecting every banknote from the large or small storage 31 or 32, the number of banknotes to be collected is relatively large, and the collection process may require longer time. In this case, the controller 15 selects the second collection process using the route through which the banknotes do not pass through the recognition unit 24 as shown in FIG. 17. This can shorten the time for the collection process as much as possible. The storage from which the banknotes are to be collected feeds the banknotes until it becomes empty. Counting of the collected banknotes is not essential. However, the controller 15 may count the number of the collected banknotes based on the detection signal of any one of the tracking sensors. Specifically, the controller 15 selectively performs either the first collection process or the second collection process based on whether only a designated number of banknotes are to be collected or every banknote in the storage is to be collected.

The controller 15 may select either the first collection process or the second collection process based on the number of banknotes to be collected. For example, if the data stored in the storage 26 shows that the storage from which the banknotes are to be collected is storing fewer banknotes than a predetermined number, the controller 15 may select the first collection process shown in FIG. 16. If the storage from which the banknotes are to be collected is storing the banknotes by number more than or equal to a predetermined number, the controller 15 may select the second collection process shown in FIG. 17. This can shorten the time required for the collection process. Specifically, the controller 15 selectively performs either the first collection process or the second collection process based on whether the number of banknotes to be collected is large or small.

Further, the controller 15 may select either the first collection process shown in FIG. 16 or the second collection process shown in FIG. 17 based on the combination of two conditions, namely, whether only some or all of the banknotes in the storage are to be collected, and the number of banknotes to be collected. Specifically, the controller 15 selectively performs either the first collection process or the second collection process based on whether the designated number is large or small when only the designated number of banknotes is to be collected, or whether the number of banknotes stored in the target storage is large or small when every banknote is to be collected.

The banknote handling apparatus 1 selects either the first route that passes through the recognition unit 24 or the second route that does not pass through the recognition unit 24 in the collection process, which makes the banknote handling apparatus 1 more convenient. Specifically, when performing the collection process, the banknote handling apparatus 1 can select either the first route that passes through the recognition unit 24 or the second route that does not pass through the recognition unit 24 in accordance with the specific condition, which can be: the manual operation; whether only some or all of the banknotes in the storage are to be collected; whether the number of banknotes to be collected is more than or equal to the predetermined number; and a combination of these conditions.

The controller 15 may select either the first collection process shown in FIG. 16 or the second collection process shown in FIG. 17 in accordance with the number of denominations of the banknotes to be collected. For example, if the number of denominations is less than a predetermined number, the first collection process may be selected because the recognition unit 24 performs the recognition with fewer loads in a shorter time. If the number of denominations is more than the predetermined number, the second collection process may be selected because the recognition unit 24 performs the recognition with greater load in a longer time.

If the storage 26 stores accurate data about the banknotes stored in the target storage (e.g., if the target storage does not require the reconciliation process), the controller 15 determines that the banknotes to be collected do not require the recognition, and selects the second collection process.

FIGS. 16 and 17 respectively show the collection processes using the external storage 35. These collection processes require the external storage 35 attached to the body of the apparatus. This requires time and labor for attaching the external storage 35 to the body of the apparatus.

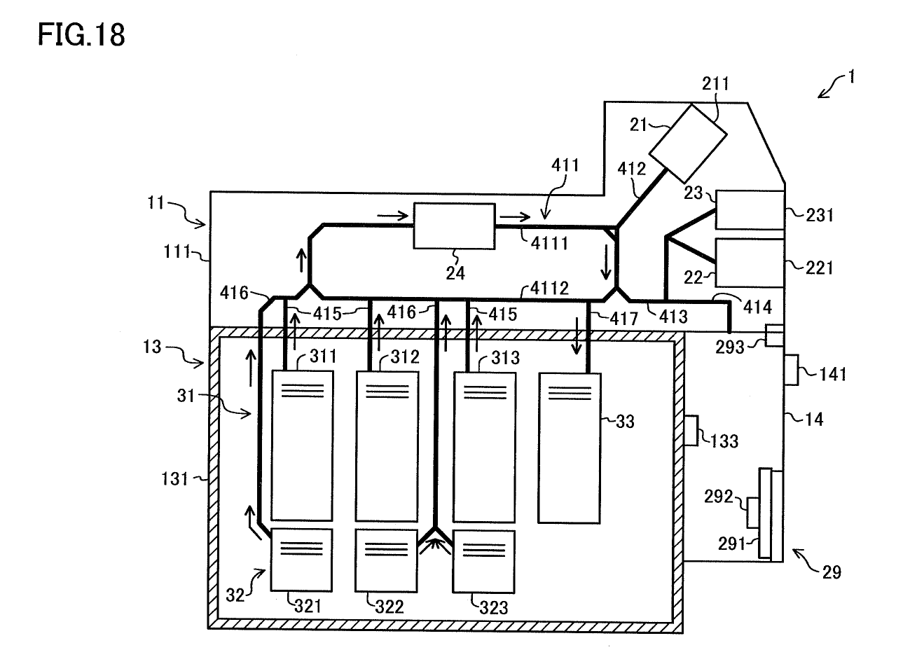

FIG. 18 shows an example of how the banknotes travel in a collection process using the multi-purpose storage 33. When the collection process starts, the large or small storage 31 or 32, from which the banknotes are to be collected, feeds the banknotes as indicated by solid line arrows in FIG. 18. The transporter 4 transports the banknotes to the recognition unit 24 through the connection path 415 or 416 and the loop transport path 411. The recognition unit 24 recognizes the banknotes. As indicated by the solid line arrows, the transporter 4 transports banknotes recognized as normal banknotes to the multi-purpose storage 33 through the loop transport path 411 and the connection path 417. The multi-purpose storage 33 stores the banknotes.

The collection process can be efficiently performed with use of the multi-purpose storage 33.

A human can arbitrarily select the collection process using the external storage 35 or the collection process using the multi-purpose storage 33 by manually operating the operation unit 27 or the terminal 16.

Switching between the collection process using the external storage 35 and the collection process using the multi-purpose storage 33 may be performed depending on the state of the banknote handling apparatus 1 or any other conditions. For example, if the external storage 35 cannot be attached while the banknote handling apparatus 1 is in normal use, or if the banknote handling apparatus 1 is unattended (e.g., when the collection process is performed out of business hours such as at nighttime according to a predetermined schedule, or when the banknote handling apparatus 1 is instructed to perform the collection process from a remote location via the terminal 16 or any other means), the controller 15 may automatically perform the collection process using the multi-purpose storage 33. This can improve the security level during the collection process. For example, if a predetermined condition has been met, the controller 15 may control the banknote handling apparatus 1 such that the collection process using the external storage 35 cannot be designated, but only the collection process using the multi-purpose storage 33 can be designated.

If the collection process is performed in the presence of a crew from a cash-in-transit company, or in an attended situation (e.g., the operation unit 27 is operated to instruct the banknote handling apparatus 1 to perform the collection process), the controller 15 may perform the collection process using the external storage 35. This collection process does not require the door 132 of the safe housing 131 to be opened, and can be performed with a high security level. The external storage 35 storing the banknotes to be collected can be detached from the body of the apparatus, and transported as it is. If a predetermined condition has been met, the controller 15 may control the banknote handling apparatus 1 so that the collection process using the external storage 35 is designated.

If the multi-purpose storage 33 stores banknotes that should not be collected therein, only the collection process using the external storage 35 can be selected.

Although not shown, the collection process shown in FIG. 16 and the collection process shown in FIG. 18 may be combined. Specifically, the collection process may be performed using both of the external storage 35 and the multi-purpose storage 33. This increases the capacity of the storage that stores the banknotes to be collected, and thus, a large number of banknotes can be collected. For example, if the number of banknotes to be collected is more than or equal to a predetermined number, the collection process may be performed using both of the external storage 35 and the multi-purpose storage 33. If the number of the banknotes to be collected is less than the predetermined number, the collection process may be performed using either the external storage 35 or the multi-purpose storage 33.

Further, based on the result of the recognition by the recognition unit 24, the transporter 4 may transport banknotes of a particular denomination to one of the external storage 35 or the multi-purpose storage 33, and transport banknotes of other denominations to the other one of the external storage 35 or the multi-purpose storage 33. In the collection process, the banknotes may be sorted by denomination and separately stored in two storages, namely, the external storage 35 and the multi-purpose storage 33.

Further, based on the result of the recognition by the recognition unit 24, the transporter 4 may transport unfit banknotes to the external storage 35, and fit banknotes to the multi-purpose storage 33. In the collection process, the banknotes may be sorted by fitness and separately collected in two storages, namely, the external storage 35 and the multi-purpose storage 33. Alternatively, the banknotes may be sorted by currency and collected in two storages, namely, the external storage 35 and the multi-purpose storage 33.

The collection process may be performed using the first dispensing unit 22 in addition to the external storage 35 and the multi-purpose storage 33.

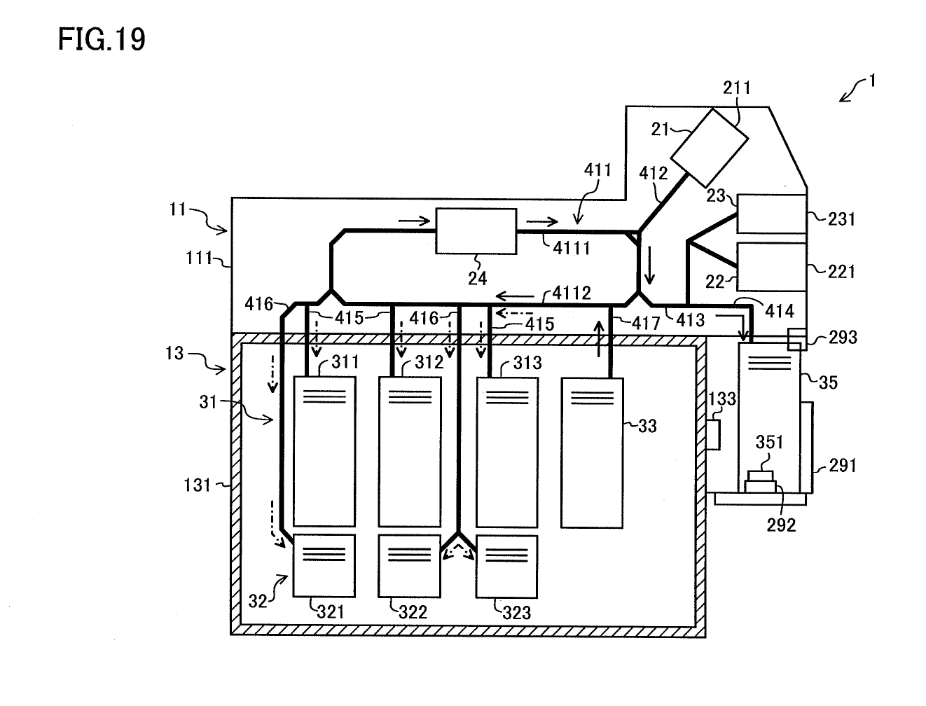

FIG. 19 shows an example of how the banknotes stored in the multi-purpose storage 33 are collected into the external storage 35.

When the collection process starts upon attachment of the external storage 35 to the body of the apparatus, the multi-purpose storage 33 feeds the banknotes as indicated by solid line arrows in FIG. 19. The transporter 4 transports the banknotes to the recognition unit 24 through the connection path 417 and the lower path 4112. The recognition unit 24 recognizes the banknotes. At this time, the recognition unit 24 recognizes the banknotes as banknotes that can be used for the dispense when stored in the large or small storage 31 or 32 of the banknote handling apparatus 1, or banknotes that cannot be used for the dispense. The transporter 4 transports the banknotes that can be used for the dispense to an associated one of the large or small storage 31 or 32 through the lower path 4112 and the connection path 415 or 416 as indicated by the dashed line arrows. The large or small storage 31 or 32 stores the banknotes.

Further, the transporter 4 transports the banknotes that cannot be used for the dispense to the external storage 35 through the loop transport path 411 and the connection paths 413 and 414 as indicated by solid line arrows. For example, if the large or small storage 31 or 32 is full or nearly full and cannot store the banknotes any more, the transporter 4 transports the banknotes to the external storage 35. The external storage 35 stores the banknotes.

This process is equivalent to the collection process and the replenishment process performed in parallel. Simultaneously performing the two processes in parallel can save time. Further, since the storage is replenished with the banknotes, the banknote handling apparatus 1 can operate for a longer time.

### (Reconciliation Process)

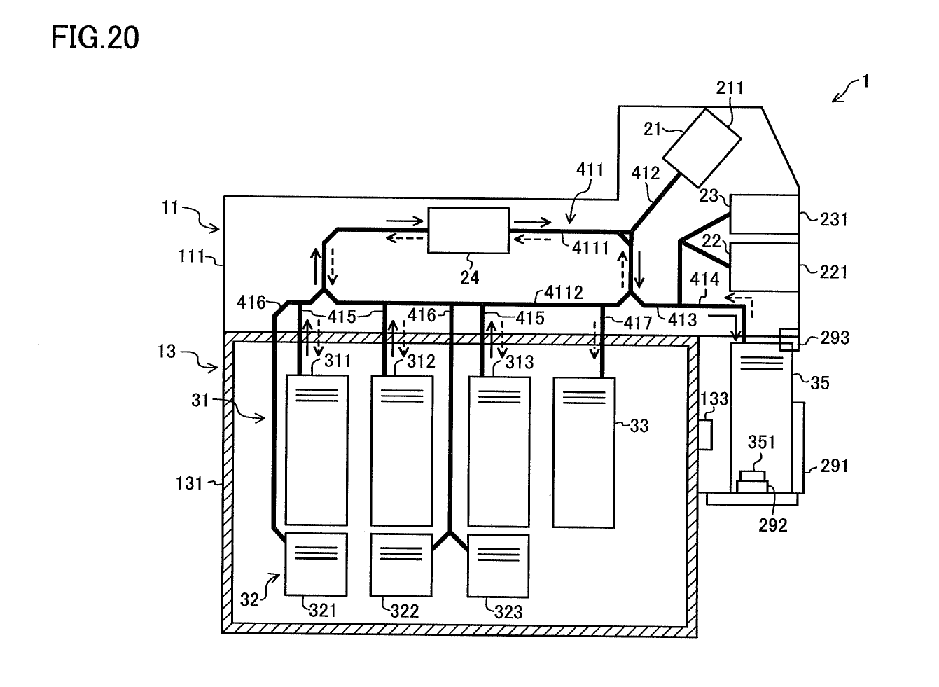

FIGS. 20 to 22 show an example of how the banknotes travel in a reconciliation process of accepting the inventory amount of the large or small storage 31 or 32 storing the banknotes sorted by denomination, for example. The banknote handling apparatus 1 has three predetermined levels of the reconciliation process, namely, a high level, a mid-level, and a low level. When instructing the banknote handling apparatus 1 to perform the reconciliation process, an operator selects a desired one of the three levels.

The banknote handling apparatus 1 performs the reconciliation process using the external storage 35. Use of the external storage 35 does not require an empty storage for the reconciliation process to be disposed in the housing of the banknote handling apparatus 1. This can advantageously downsize the banknote handling apparatus 1. In addition, the capacity of the banknote handling apparatus 1 can be increased.

FIG. 20 shows an example of how the banknotes travel in a high-level reconciliation process. In particular, FIG. 20 shows how the banknotes travel when the reconciliation process is sequentially performed on the first, second, and third large storages 311, 312, and 313, and the multi-purpose storage 33 in this order. The reconciliation process on the multi-purpose storage 33 is performed last. Note that the order of the reconciliation process is the same for the small storages 32.

As indicated by solid line arrows in FIG. 20, the large storage 31, which is the target of the reconciliation, feeds the banknotes. The transporter 4 transports the banknotes to the recognition unit 24 through the connection path 415 and the loop transport path 411. The recognition unit 24 recognizes the banknotes.

The transporter 4 transports the banknotes that have passed through the recognition unit 24 to the external storage 35 through the loop transport path 411 and the connection paths 413 and 414. This transport of the banknotes will be referred to as “primary transport.” The external storage 35 stores the banknotes.

If some banknotes are recognized by the recognition unit 24 as banknotes to be rejected, the transporter 4 transports the rejected banknotes to the multi-purpose storage 33 as indicated by dashed line arrows in FIG. 20. The banknotes rejected in the reconciliation process include banknotes rejected due to transport anomaly described above, and banknotes of different denominations from those to be stored in the storage.

The multi-purpose storage 33 stores the rejected banknotes. That is, the rejected banknotes are stored in the storage on which the reconciliation process is performed last. Therefore, the reconciliation process does not stop every time the banknote is rejected. This allows the reconciliation process to smoothly proceed. In addition, time required for the reconciliation process is shortened.

When all the banknotes fed from the large storage 31, which is the reconciliation target, are stored in the external storage 35, the external storage 35 feeds the banknotes as indicated by dashed line arrows. The transporter 4 transports the fed banknotes to the recognition unit 24 through the connection paths 414 and 413 and the upper path 4111. The recognition unit 24 recognizes the banknotes again. The transporter 4 returns the banknotes that have passed through the recognition unit 24 to the large storage 31 through the loop transport path 411 and the connection path 415. This transport of the banknotes will be referred to as “secondary transport.” The large storage 31 stores the returned banknotes again. The reconciliation process on the single large storage 31 ends when all the banknotes fed from the external storage 35 are stored in the large storage 31.

The controller 15 performs the reconciliation process on the large storage 31, which is the next target of the reconciliation, in the above-described manner.

When the reconciliation process on the three large storages 311, 312, and 313 is finished, the reconciliation process is performed on the multi-purpose storage 33. The reconciliation process for the multi-purpose storage 33 will be described later.

Note that the high-level reconciliation process on the small storages 32 can be performed in the same manner.

As shown in FIG. 20, in the high-level reconciliation process, the recognition unit 24 performs the recognition in each of the primary transport of the banknotes from the large or small storage 31 or 32 to the external storage 35 and the secondary transport of the banknotes from the external storage 35 to the large or small storage 31 or 32. The recognition unit 24 recognizes each banknote twice. This can achieve a high-level reconciliation process.

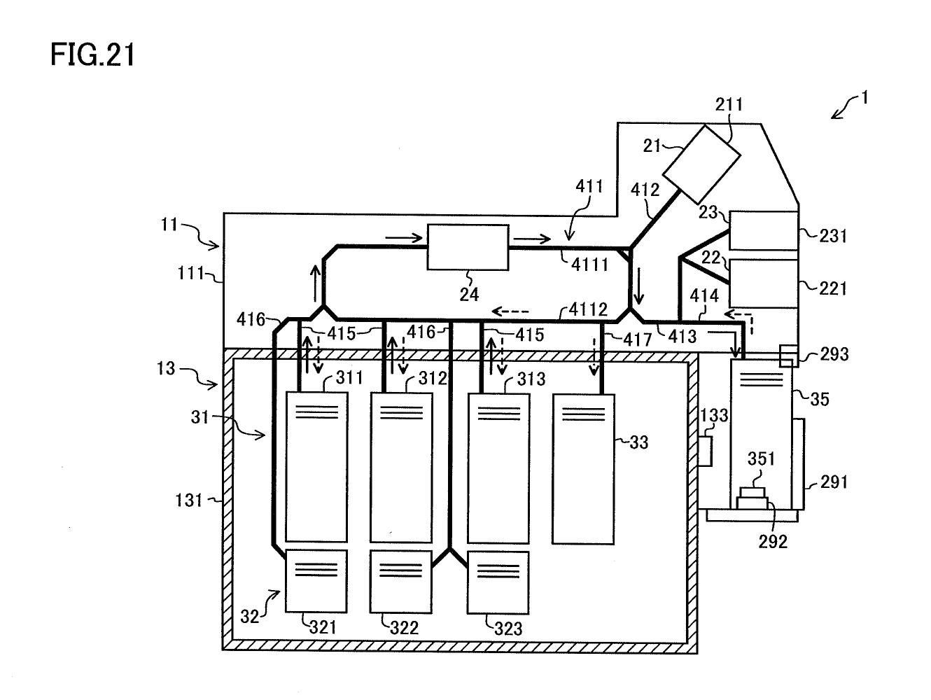

FIG. 21 shows an example of how the banknotes travel in a mid-level reconciliation process. FIG. 21 also shows how the banknotes travel when the reconciliation process is sequentially performed on the first, second, and third large storages 311, 312, and 313, and the multi-purpose storage 33 in this order. The reconciliation process on the multi-purpose storage 33 is performed last. Note that the order of the reconciliation process is the same for the small storages 32.

As indicated by solid line arrows in FIG. 21, the large storage 31, which is the target of the reconciliation, feeds the banknotes. The transporter 4 transports the banknotes to the recognition unit 24 through the connection path 415 and the loop transport path 411. The recognition unit 24 recognizes the banknotes.

The transporter 4 transports the banknotes that have passed through the recognition unit 24 to the external storage 35 through the loop transport path 411 and the connection paths 413 and 414 (i.e., the primary transport). The external storage 35 stores the banknotes.

If some banknotes are recognized by the recognition unit 24 as banknotes to be rejected, the transporter 4 transports the rejected banknotes to the multi-purpose storage 33 as indicated by dashed line arrows in FIG. 21. The multi-purpose storage 33 stores the rejected banknotes.

When all the banknotes fed from the large storage 31, which is the reconciliation target, are stored in the external storage 35, the external storage 35 feeds the banknotes as indicated by dashed line arrows. The transporter 4 returns the fed banknotes to the large storage 31 through the connection paths 414 and 413, the lower path 4112, and the connection path 415 (i.e., the secondary transport). The large storage 31 stores the returned banknotes again. The reconciliation process on the single large storage 31 ends when all the banknotes fed from the external storage 35 are stored in the large storage 31.

The controller 15 performs the reconciliation process on the large storage 31, which is the next target of the reconciliation, in the above-described manner.

When the reconciliation process on the three large storages 311, 312, and 313 is finished, the reconciliation process is performed on the multi-purpose storage 33. The reconciliation process for the multi-purpose storage 33 will be described later.

Note that the mid-level reconciliation process on the small storages 32 can be performed in the same manner.

As shown in FIG. 21, in the mid-level reconciliation process, the recognition unit 24 performs the recognition in the primary transport of the banknotes from the large or small storage 31 or 32 to the external storage 35, but does not perform the recognition in the secondary transport of the banknotes from the external storage 35 to the large or small storage 31 or 32. The recognition unit 24 recognizes each banknote once. The level of the reconciliation is relatively lowered. However, the mid-level reconciliation process can be performed in a shorter time because the single recognition is skipped and the route for transporting the banknotes without passing through the recognition unit 24 is relatively short.

Contrary to the example shown in FIG. 21, the banknotes may not pass through the recognition unit 24 during the primary transport from the large or small storage 31 or 32 to the external storage 35, and the recognition unit 24 may recognize the banknotes during the secondary transport from the external storage 35 to the large or small storage 31 or 32.

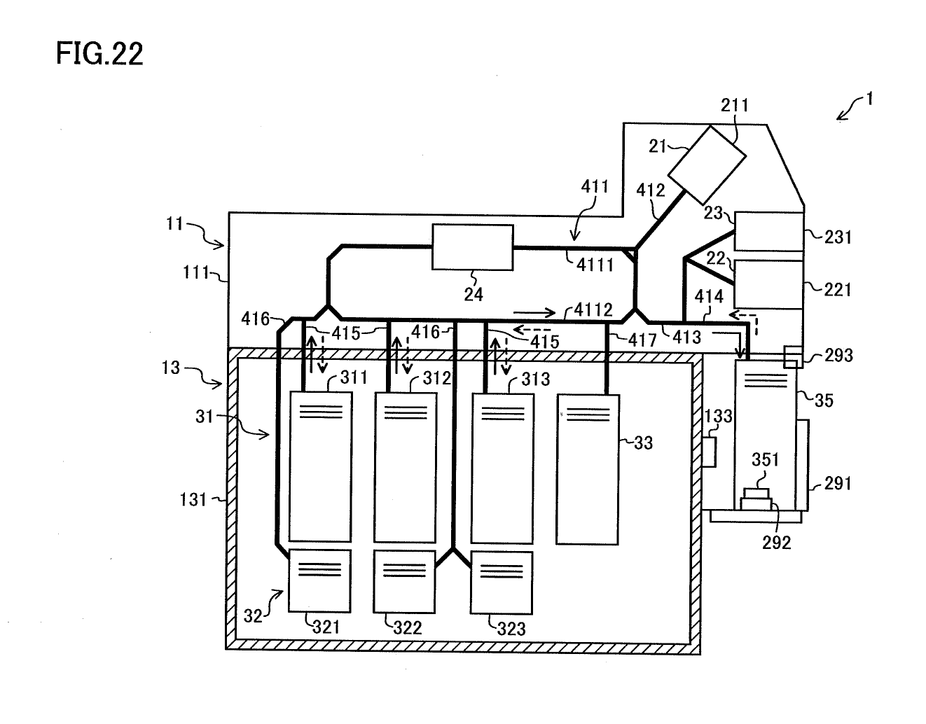

FIG. 22 shows an example of how the banknotes travel in a low-level reconciliation process. FIG. 22 also shows how the banknotes travel when the reconciliation process is sequentially performed on the first, second, and third large storages 311, 312, and 313, and the multi-purpose storage 33 in this order. The reconciliation process on the multi-purpose storage 33 is performed last. Note that the order of the reconciliation process is the same for the small storages 32.

As indicated by solid line arrows in FIG. 22, the large storage 31, which is the target of the reconciliation, feeds the banknotes. The transporter 4 transports the banknotes to the external storage 35 through the connection path 415 and the lower path 4112 without passing through the recognition unit 24. In the middle of the primary transport, the tracking sensor on the transport path counts the banknotes. The external storage 35 stores the banknotes. In the low-level reconciliation process, no recognition is performed, and thus, no banknotes are rejected.

When all the banknotes fed from the storage 31, which is the reconciliation target, are stored in the external storage 35, the external storage 35 feeds the banknotes as indicated by dashed line arrows. The transporter 4 returns the fed banknotes to the large storage 31 through the connection paths 414 and 413, the lower path 4112, and the connection path 415. In this secondary transport, the banknotes do not pass through the recognition unit 24. The tracking sensor arranged in the middle of the transport path counts the banknotes. The large storage 31 stores the returned banknotes again. The reconciliation process on the single large storage 31 ends when all the banknotes fed from the external storage 35 are stored in the large storage 31.

The controller 15 performs the reconciliation process on the large storage 31, which is the next target of the reconciliation, in the above-described manner.

When the reconciliation process on the three large storages 311, 312, and 313 is finished, the reconciliation process is performed on the multi-purpose storage 33. The reconciliation process for the multi-purpose storage 33 will be described later.

Note that the low-level reconciliation process for the small storages 32 can be performed in the same manner.

As shown in FIG. 22, in the low-level reconciliation process, the recognition unit 24 performs no recognition in both of the primary transport of the banknotes from the large or small storage 31 or 32 to the external storage 35 and the secondary transport of the banknotes from the external storage 35 to the large or small storage 31 or 32. The low-level reconciliation process merely counts the banknotes, and thus, the level of the reconciliation is low. However, the low-level reconciliation process can be performed in a very short time owing to the skip of the recognition and the shortened route for transporting the banknotes. Since the recognition is skipped, the transporter 4 may transport the banknotes at a higher speed than in the high-level and mid-level reconciliation processes.

The banknote handling apparatus 1 offers improved convenience because the route that passes through the recognition unit 24 or the route that does not pass through the recognition unit 24 is selected in accordance with the level of the reconciliation process. Specifically, when performing the reconciliation process, the banknote handling apparatus 1 can select either the first route that passes through the recognition unit 24 or the second route that does not pass through the recognition unit 24 in accordance with the specific condition about the level of the reconciliation process.

In this example, how the banknotes travel in the reconciliation process has been described taking the case where the reconciliation process is sequentially performed on a plurality of storages as an example. However, the reconciliation process is not necessarily performed on a plurality of storages. The reconciliation process may be performed on a single storage. In such a case, if some banknotes are rejected during the reconciliation process, they may be stored in the multi-purpose storage 33 or transported to the first or second dispensing unit 22 or 23. As will be described later, when provided with the temporary storage 34, the banknote handling apparatus 1 may store the rejected banknotes in the temporary storage 34. The destination of the banknotes rejected during the reconciliation process may be determined in accordance with the manual operation of the operation unit 27 or the terminal 16. The controller 15 may automatically determine the destination of the banknotes rejected during the reconciliation process in accordance with a predetermined specific condition.

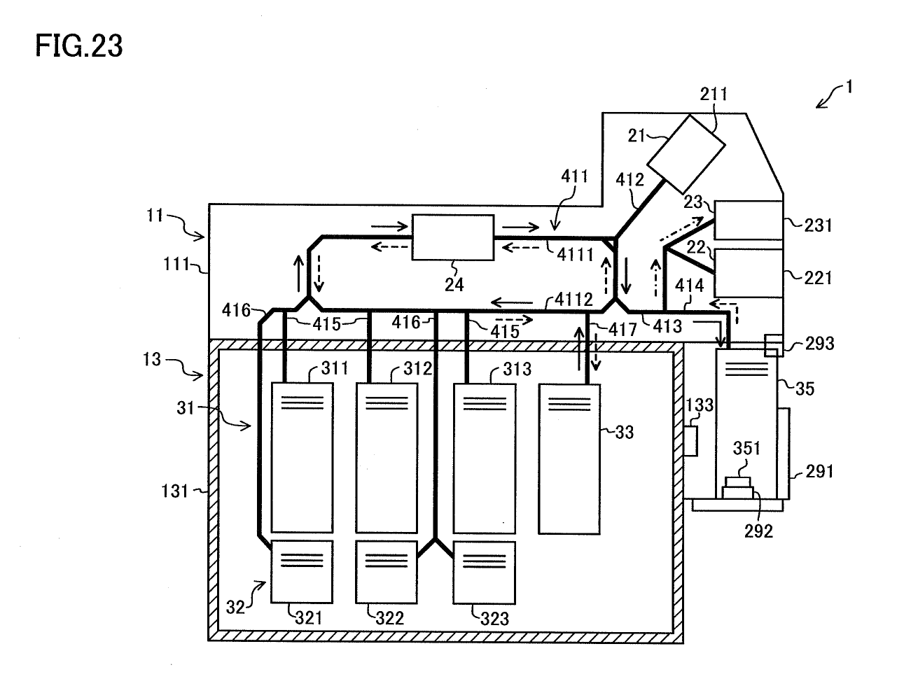

FIG. 23 shows an example of how the banknotes travel in a reconciliation process performed on the multi-purpose storage 33. The reconciliation process is performed on the multi-purpose storage 33 when the reconciliation process is sequentially performed on a plurality of storages, or on the multi-purpose storage 33 only.

As indicated by solid line arrows in FIG. 23, the multi-purpose storage 33 feeds the banknotes. The transporter 4 transports the banknotes to the recognition unit 24 through the connection path 417 and the lower path 4112 of the loop transport path 411. The recognition unit 24 recognizes the banknotes.

The transporter 4 transports the banknotes that have passed through the recognition unit 24 to the external storage 35 through the loop transport path 411 and the connection paths 413 and 414 as indicated by solid line arrows (i.e., the primary transport). The external storage 35 stores the banknotes.

If some banknotes are recognized by the recognition unit 24 as banknotes to be rejected, the transporter 4 transports the rejected banknotes to the second dispensing unit 23 through the loop transport path 411 and the connection path 413 as indicated by dashed line arrows.

When all the banknotes fed from the storage 31, which is the reconciliation target, are stored in the external storage 35, the external storage 35 feeds the banknotes as indicated by dashed line arrows. The transporter 4 transports the fed banknotes to the recognition unit 24 through the connection paths 414 and 413 and the upper path 4111. The recognition unit 24 recognizes the banknotes again. The transporter 4 transports the banknotes that have passed through the recognition unit 24 to the multi-purpose storage 33 through the lower path 4112 and the connection path 417 (i.e., the secondary transport). The multi-purpose storage 33 stores the banknotes. The reconciliation process on the multi-purpose storage 33 ends when all the banknotes are fed from the external storage 35 and the fed banknotes are stored in the multi-purpose storage 33. Thus, the inventory amount of the multi-purpose storage 33 is accepted.

The banknote handling apparatus 1 can perform the reconciliation process on the multi-purpose storage 33 which stores banknotes rejected in the dispensing process, and banknotes rejected in the reconciliation process.

If the banknotes rejected in the reconciliation process are stored in the multi-purpose storage 33 on which the reconciliation process is performed last, the rejected banknotes go through the reconciliation process at least two times during the reconciliation process. That is, the banknotes once rejected due to the transport anomaly or any other cause may not be rejected in the second reconciliation process. Further, if some banknotes are rejected due to an error concerning the denomination in the reconciliation process performed on the large or small storage 31 or 32 storing the banknotes sorted by denomination, the banknotes may not be rejected in the reconciliation process performed on the multi-purpose storage 33. Thus, the second reconciliation process can reduce the number of the rejected banknotes. This can reduce the failure of the reconciliation process.

Further, since the reconciliation process is performed several times while the banknotes rejected in the reconciliation process are kept stored in the safe housing 131, the security level improves.

The rejected banknotes dispensed to the second dispensing unit 23 during the reconciliation process performed on the multi-purpose storage 33 may be manually removed and placed in the depositing unit 21 after the end of the transport of every banknote so that the banknote handling apparatus 1 can take the banknotes in again. The transporter 4 may transport the banknotes to the recognition unit 24, and then store the banknotes recognized by the recognition unit 24 in the large or small storage 31 or 32, or the multi-purpose storage 33. The rejected banknotes removed from the second dispensing unit 23 may be separately managed without being taken into the apparatus.

In the example shown in FIG. 23, just like in the example of the high-level reconciliation process shown in FIG. 20, each banknote fed from the multi-purpose storage 33 is recognized in each of the primary transport and the secondary transport. Alternatively, just like in the example of the mid-level reconciliation process shown in FIG. 21, each banknote fed from the multi-purpose storage 33 may be recognized in either the primary transport or the secondary transport.

Further, just like in the example of the low-level reconciliation process shown in FIG. 22, each banknote fed from the multi-purpose storage 33 may go through the reconciliation process with no recognition.

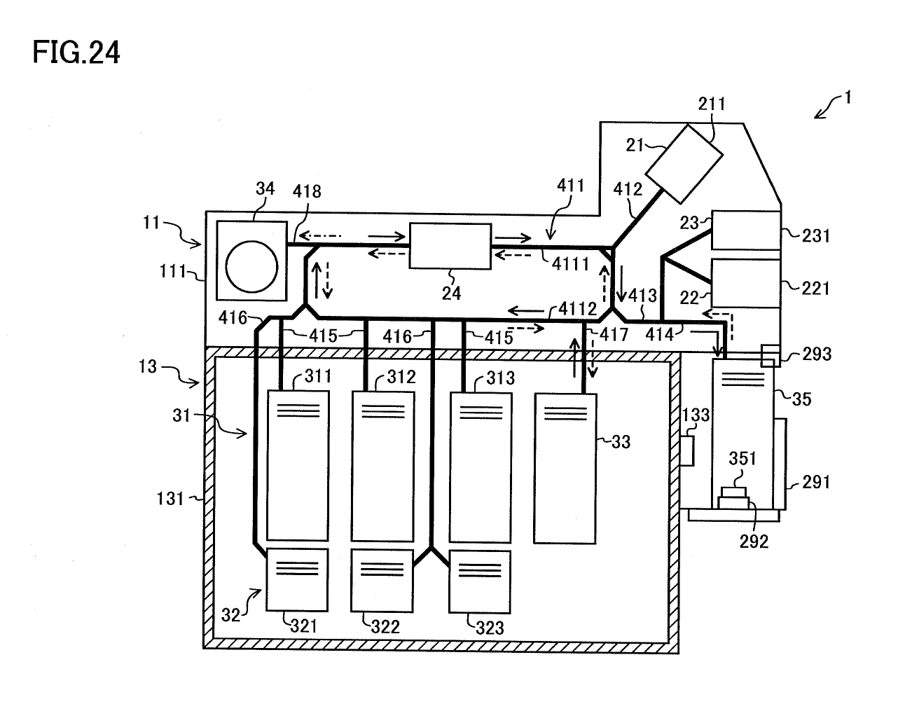

FIG. 24 shows an example of how the banknotes travel in the banknote handling apparatus 1 including the temporary storage 34 during a reconciliation process performed on the multi-purpose storage 33. In the example shown in FIG. 23, the banknotes rejected during the reconciliation process performed on the multi-purpose storage 33 are transported to the second dispensing unit 23. In contrast, in the example shown in FIG. 24, the banknotes rejected during the reconciliation process performed on the multi-purpose storage 33 are transported to the temporary storage 34.

Solid line arrows in FIG. 24 are the same as those in FIG. 23. The transporter 4 transports the banknotes fed from the multi-purpose storage 33 to the recognition unit 24 through the connection path 417 and the loop transport path 411. The recognition unit 24 recognizes the banknotes. The transporter 4 transports the banknotes that have passed through the recognition unit 24 to the external storage 35 through the loop transport path 411 and the connection paths 413 and 414 (i.e., the primary transport). The external storage 35 stores the banknotes.

Dashed line arrows in FIG. 24 are also the same as those in FIG. 23. The transporter 4 transports the banknotes fed from the external storage 35 to the recognition unit 24 through the connection paths 414 and 413 and the upper path 4111. The recognition unit 24 recognizes the banknotes again. The transporter 4 transports the banknotes that have passed through the recognition unit 24 to the multi-purpose storage 33 through the lower path 4112 of the loop transport path 411 and the connection path 417 (i.e., the secondary transport). The multi-purpose storage 33 stores the banknotes.

The transporter 4 transports some banknotes recognized as banknotes to be rejected to the temporary storage 34 through the connection path 418 as indicated by dashed line arrows. The temporary storage 34 stores the banknotes.

The secondary transport ends when all the banknotes fed from the external storage 35 are stored in the multi-purpose storage 33.

The temporary storage 34 feeds the stored banknotes after the secondary transport ends. The transporter 4 may transport the banknotes fed from the temporary storage 34 to the multi-purpose storage 33 to be stored therein. In this case, the inventory amount of the multi-purpose storage 33 is not accepted. The transporter 4 may transport the banknotes fed from the temporary storage 34 to the second dispensing unit 23 to be dispensed thereto. In this case, the inventory amount of the multi-purpose storage 33 is accepted. The temporary holding unit 34 becomes empty, and the reconciliation process using the temporary storage 34 ends.

Also in the example shown in FIG. 24, just like in the example of the mid-level reconciliation process shown in FIG. 21, each banknote fed from the multi-purpose storage 33 may be recognized in either the primary transport or the secondary transport.

Further, also in the example of FIG. 24, just like in the example of the low-level reconciliation process shown in FIG. 22, each banknote fed from the multi-purpose storage 33 may go through the reconciliation process with no recognition.

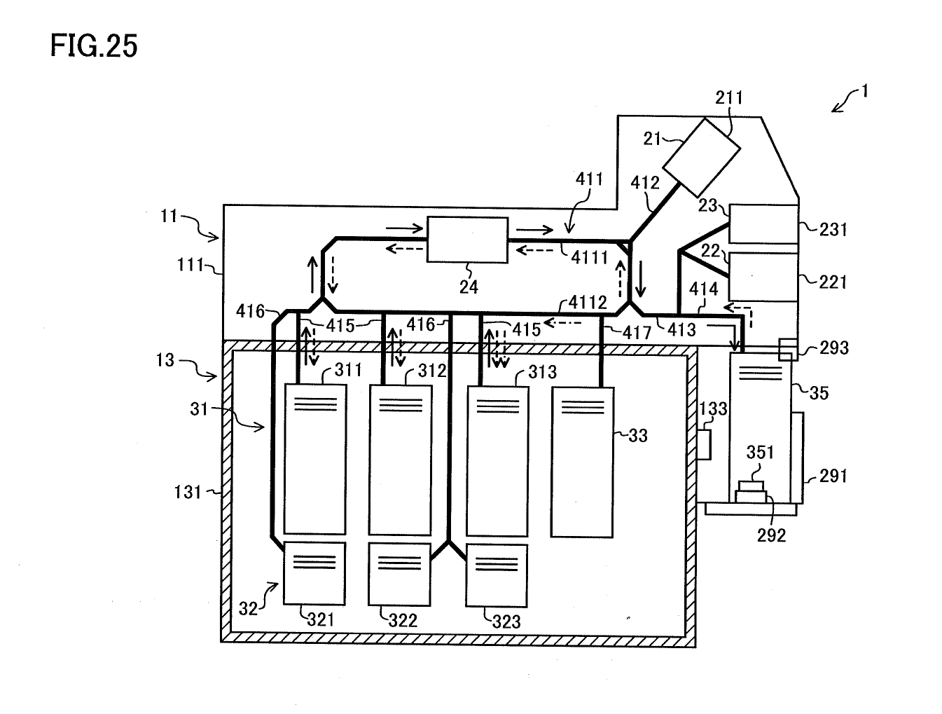

FIG. 25 shows an example of how the banknotes travel when the reconciliation process is sequentially performed on a plurality of storages (first to third large storages 31 in the illustrated example). The example of FIG. 25 is different from that of FIG. 20 in that no reconciliation process is performed on the multi-purpose storage 33. The example of FIG. 25 is applicable to a banknote handling apparatus 1 having no multi-purpose storage 33. In the example of FIG. 25, the reconciliation process is sequentially performed on the first, second, and third large storages 311, 312, and 313 in this order. The reconciliation process may be performed on two storages. Note that the following sequential reconciliation process is performed in the same manner on the small storages 32.

Solid line arrows in FIG. 25 are the same as those in FIG. 20. The transporter 4 transports the banknotes fed from the storage 31, which is the reconciliation target, to the recognition unit 24 through the connection path 415 and the loop transport path 411. The recognition unit 24 recognizes the banknotes.

The transporter 4 transports the banknotes that have passed through the recognition unit 24 to the external storage 35 through the connection paths 413 and 414 (i.e., the primary transport). The external storage 35 stores the banknotes.

If some banknotes are recognized by the recognition unit 24 as banknotes to be rejected, the transporter 4 transports the rejected banknotes to the storage on which the reconciliation process will be performed last, i.e., the third large storage 313 in this example, through the lower path 4112 and the connection path 415 as indicated by dashed line arrows. The third large storage 313 stores the rejected banknotes.

When all the banknotes fed from the storage 31, which is the reconciliation target, are stored in the external storage 35, the external storage 35 feeds the banknotes as indicated by dashed line arrows. The transporter 4 transports the fed banknotes to the recognition unit 24 through the connection paths 414 and 413 and the upper path 4111. The recognition unit 24 recognizes the banknotes again. The transporter 4 returns the banknotes that have passed through the recognition unit 24 to the large storage 31 through the loop transport path 411 and the connection path 415 (i.e., the secondary transport). The large storage 31 stores the returned banknotes again. The reconciliation process on the single large storage 31 ends when all the banknotes fed from the external storage 35 are stored in the large storage 31.

The controller 15 performs the reconciliation process on the second large storage 312, which is the next target of the reconciliation, in the above-described manner. Banknotes rejected during the reconciliation process performed on the second large storage 312 are also transported to the third large storage 313 as described above, and stored therein.

When the reconciliation process on the second large storage 312 ends, the controller 15 last performs the reconciliation process on the third large storage 313 in the above-described manner. The third large storage 313 stores the banknotes rejected during the reconciliation process performed on the first large storage 311 and/or the second large storage 312. This means that the rejected banknotes will be recognized once more. If some of the rejected banknotes are recognized as normal banknotes through the second recognition, these banknotes are stored in an associated one of the storages 31. This can reduce the number of rejected banknotes, as a result of which the failure of the reconciliation can be reduced.

Banknotes rejected during the reconciliation process performed on the third large storage 313 may be transported to, for example, the second dispensing unit 23. The rejected banknotes dispensed to the second dispensing unit 23 may be taken into the apparatus again through the depositing unit 21 after the end of the secondary transport. Alternatively, the rejected banknotes may be stored in the multi-purpose storage 33. Specifically, the controller 15 may change the destination of the banknotes rejected during the reconciliation process depending on the storage as the reconciliation target.

When provided with the temporary storage 34, the banknote handling apparatus 1 may temporarily store the rejected banknotes in the temporary storage 34. The rejected banknotes stored in the temporary storage 34 may be fed out after the end of the secondary transport. The banknotes fed from the temporary storage 34 may be returned and stored in the third large storage 313. The banknotes fed from the temporary storage 34 may be stored in an associated one of the storages after going through the recognition once more. The rejected banknotes stored in the temporary storage 34 may be fed and dispensed to the second dispensing unit 23 after the end of the secondary transport.

To the example shown in FIG. 25, the mid-level reconciliation process shown in FIG. 21 or the low-level reconciliation process shown in FIG. 22 may be applied. In the mid-level reconciliation process, the recognition of the banknotes may be performed in either the primary transport or the secondary transport.

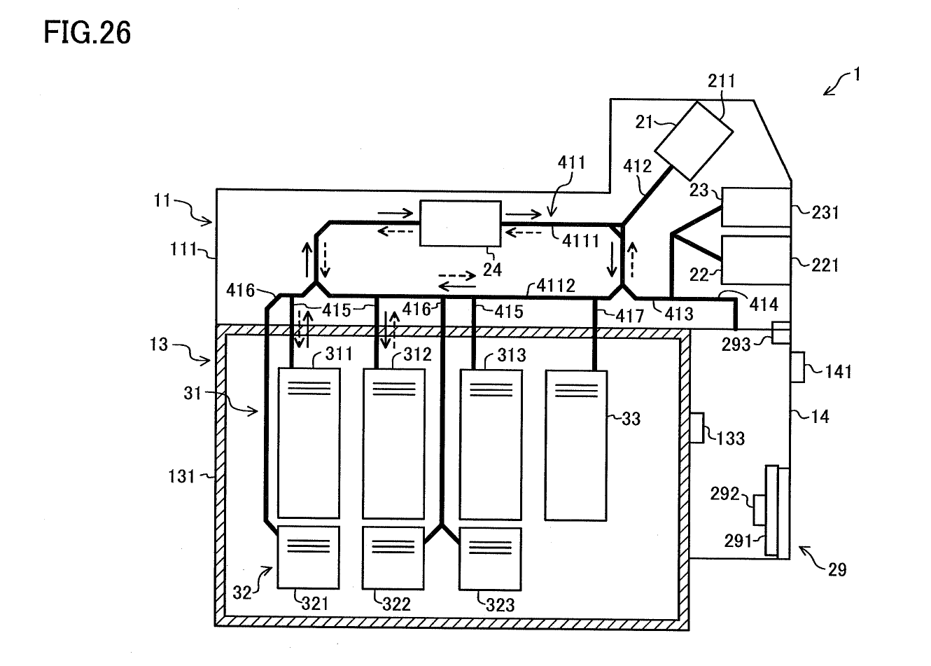

FIG. 26 shows an example of how the banknotes travel in a reconciliation process using, not the external storage 35, but an available capacity of any other storages than the storage as the reconciliation target. In the example of FIG. 26, the first large storage 311 is selected as the reconciliation target, and the reconciliation process is performed using an available capacity of the second large storage 312.

The transporter 4 transports the banknotes fed from the first large storage 311 as the reconciliation target to the recognition unit 24 through the connection path 415 and the loop transport path 411 as indicated by solid line arrows in FIG. 26. The recognition unit 24 recognizes the banknotes.

The transporter 4 transports the banknotes that have passed through the recognition unit 24 to the second large storage 312 through the lower path 4112 and the connection path 415 as indicated by solid line arrows (i.e., the primary transport). The second large storage 312 stores the banknotes. The banknotes stored this time are stacked on the banknotes that have already been stored in the second large storage 312.

When all the banknotes fed from the first large storage 311 are stored in the second large storage 312, the second large storage 312 feeds the banknotes as indicated by dashed line arrows. The transporter 4 transports the fed banknotes to the recognition unit 24 through the connection path 415 and the upper path 4111. The recognition unit 24 recognizes the banknotes again. The transporter 4 transports the banknotes that have passed through the recognition unit 24 to the first large storage 311 through the loop transport path 411 and the connection path 415 (i.e., the secondary transport). The first large storage 311 stores the banknotes. The reconciliation process on the first large storage 311 ends when all the banknotes stored in the second large storage 312 during the reconciliation process are fed and stored in the first large storage 311.

The reconciliation process using the available capacity of other storage no longer requires the external storage 35. This can skip a preparation step, such as attachment of the external storage 35 to the housing of the apparatus, and allows the reconciliation process to start immediately.

The reconciliation process using the available capacity of other storage no longer requires an empty storage for the reconciliation process to be disposed in the housing of the banknote handling apparatus 1. This can advantageously downsize the banknote handling apparatus 1. In addition, the capacity of the banknote handling apparatus 1 advantageously increases.

Note that the other storage than the storage selected as the reconciliation target is not limited to a single storage. The banknotes may be temporarily stored in a plurality of storages. This can ensure a larger capacity for the temporary storage of the banknotes during the reconciliation process. As a result, the reconciliation process can smoothly proceed. The plurality of storages includes, in addition to the large storages 31 described above, the small storages 32, and the multi-purpose storage 33. Further, as will be described later, the temporary storage 34 is also included in the plurality of the storages.

When storing the banknotes in the other storage, the order of banknotes that have already been stored in the other storage and the banknotes newly stored may possibly change. Therefore, in feeding the newly stored banknotes out of the other storage, some banknotes may be fed together from the top of the stack of the banknotes previously stored in the other storage. Through the recognition of the fed banknotes by the recognition unit 24, the banknotes as the target of the reconciliation can be distinguished from the banknotes previously stored in the other storage. Among the banknotes fed from the other storage, those previously stored in the other storage may be stored again in the other storage.

In feeding the banknotes from the other storage, one or some of the previously stored banknotes may overlap with, and be fed together with the banknote being fed. In order to prevent such a phenomenon, some banknotes around the boundary between the banknotes newly stored in the other storage during the reconciliation process and the previously stored banknotes may be intermittently fed one by one.

If some banknotes are rejected during the reconciliation process using an available capacity of the other storage, the rejected banknotes may be stored in the multi-purpose storage 33 or transported to the second dispensing unit 23. If the banknote handling apparatus 1 includes the temporary storage 34, the rejected banknotes may be temporarily stored in the temporary storage 34.

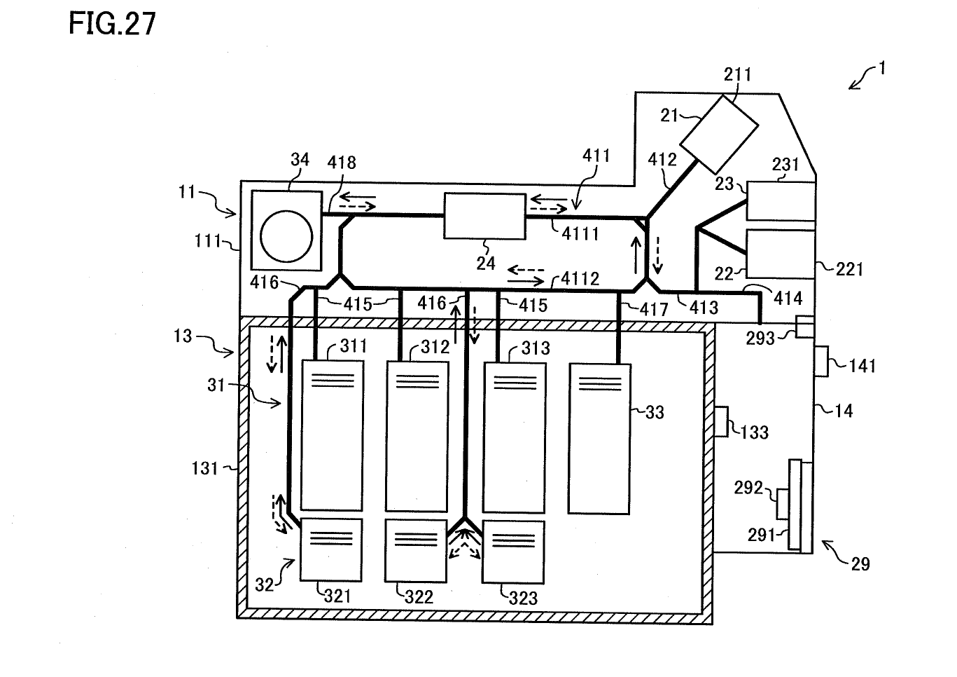

FIG. 27 shows an example of how the banknotes travel in a reconciliation process using the temporary storage 34. This reconciliation process is suitable for a case in which the number of banknotes as the target of the reconciliation is small. FIG. 27 shows an example of a reconciliation process performed on the small storage 32 having a relatively small capacity. Specifically, if the reconciliation process is performed on the storage whose maximum storage capacity is less than a predetermined level (the small storage 32 in this example), the temporary storage 34 is used. If the reconciliation process is performed on the storage whose maximum storage capacity is more than or equal to the predetermined level (the large storage 31 and the multi-purpose storage 33 in this example), the external storage 35 or the multi-purpose storage 33 may be used as described above instead of the temporary storage 34.

The transporter 4 transports the banknotes fed from the small storage 32 as the target of the reconciliation to the recognition unit 24 through the connection path 416 and the loop transport path 411 as indicated by solid line arrows in FIG. 27. The recognition unit 24 recognizes the banknotes.

As indicated by the solid line arrows, the transporter 4 transports the banknotes that have passed through the recognition unit 24 to the temporary storage 34 through the connection path 418 (i.e., the primary transport). The temporary storage 34 stores the banknotes.

When all the banknotes fed from the small storage 32 are stored in the temporary storage 34, the temporary storage 34 feeds the banknotes as indicated by dashed line arrows. The transporter 4 transports the fed banknotes to the recognition unit 24 through the connection path 418 and the upper path 4111. The recognition unit 24 recognizes the banknotes again. The transporter 4 returns the banknotes that have passed through the recognition unit 24 to the small storage 32 through the lower path 4112 and the connection path 416 (i.e., the secondary transport). The small storage 32 stores the returned banknotes. The reconciliation process on the small storage 32 ends when all the banknotes fed from the temporary storage 34 are stored in the small storage 32.

The reconciliation process using the temporary storage 34 no longer requires the external storage 35. This allows the reconciliation process to start immediately. This can advantageously downsize the banknote handling apparatus 1 because an empty storage for the reconciliation process is no longer necessary. In addition, the capacity of the banknote handling apparatus 1 advantageously increases.

Banknotes rejected during the reconciliation process may be transported to, and stored in, the multi-purpose storage 33, for example. Alternatively, the rejected banknotes may be transported to, and dispensed to, the second dispensing unit 23.

Although FIG. 27 shows an example of the reconciliation process performed on the small storage 32, the reconciliation process using the temporary storage 34 may be performed, for example, on the large storage 31 or the multi-purpose storage 33. The temporary storage 34 is a winding storage, and thus, can store and feed the banknotes with reliability irrespective of the state and size of the banknotes. The multi-purpose storage 33 may store various kinds of banknotes. If the temporary storage 34 is used for the reconciliation process on the multi-purpose storage 33, various kinds of banknotes can be stored and fed with reliability. This can advantageously achieve the reconciliation process with reliability. The large storage 31 and the multi-purpose storage 33 are not limited to the stacking storages described in this example, but may be a large storage of a winding type, and a multi-purpose storage of a winding type.

The reconciliation process may be performed, for example, in accordance with the number of banknotes stored in the storage which is the target of the reconciliation. For example, if the storage stores fewer banknotes than a predetermined number, the reconciliation process may be performed using the temporary storage 34. If the storage stores banknotes more than or equal to the predetermined number, the reconciliation process may be performed using, not the temporary storage 34, but the storage with larger capacity, e.g., the external storage 35 or the multi-purpose storage 33.

As described with reference to FIGS. 20 to 27, the banknote handling apparatus 1 can perform the reconciliation process using the external storage 35, the multi-purpose storage 33, the temporary storage 34, and the other storage than the storage selected as the target of the reconciliation. The banknote handling apparatus 1 may automatically select and determine the storage to be used in the reconciliation process in accordance with a predetermined condition (i.e., a rule).

The storage to be used in the reconciliation process may be designated in accordance with the manual operation of the terminal 16 or the operation unit 27. In this case, the banknote handling apparatus 1 may present available storages on the terminal 16 or any other means in accordance with various information, such as the maximum storage capacity of the storage as the target of the reconciliation, and the number of banknotes stored in each storage. This allows a human to select a suitable storage, and the banknote handling apparatus 1 can smoothly perform the reconciliation process using the storage with a suitable capacity.

### (Process Using External Storage)

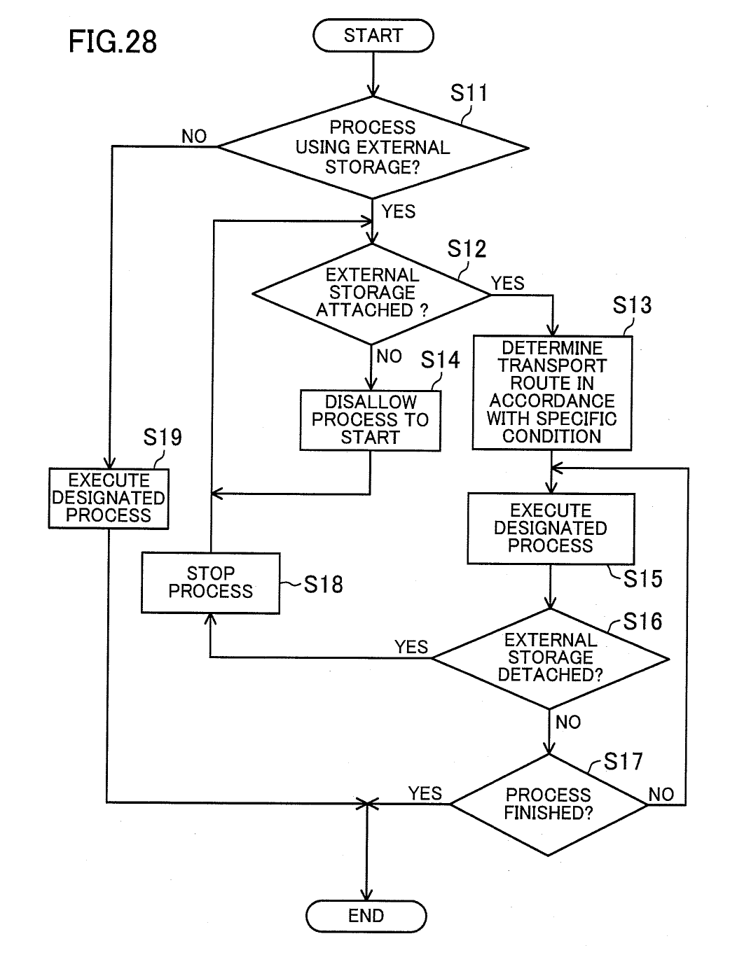

As described above, the banknote handling apparatus 1 performs the replenishment process, the collection process, and the reconciliation process using the external storage 35. FIG. 28 is a flowchart illustrating a control procedure executed by the controller 15 to perform each process using the external storage 35.

First, the flow shown in FIG. 28 starts when a human designates the banknote handling apparatus 1 to perform the process by operating the terminal 16 or the operation unit 27. In Step S11 after the start, the controller 15 determines whether the process to be performed hereafter uses the external storage 35 or not. If it is determined that the process does not use the external storage 35, i.e., the answer is NO in Step S11, the flow proceeds to Step S19. Then, the controller 15 controls the banknote handling apparatus 1 to execute the designated process (e.g., the depositing process or the dispensing process, or the replenishment process or the collection process that does not use the external storage 35).

If the answer is YES in Step S11, the flow proceeds to Step S12. In Step S12, the controller 15 determines whether the external storage 35 has been attached to the body of the apparatus or not based on the signal from the mount 293. If the external storage 35 has not been attached to the body of the apparatus (i.e., the answer is NO in Step S12), the flow proceeds to Step S14. In Step S14, the controller 15 does not allow the process to start, and the flow returns to Step S12. If the external storage 35 is attached to the body of the apparatus and the answer changes to YES in Step S12, the flow proceeds to Step S13.

In Step S13, the controller 15 determines the route for transporting the banknotes in accordance with the aforementioned specific condition. Specifically, the route for transporting the banknotes in the replenishment process may be selected from the first route that passes through the recognition unit 24 and the second route that does not pass through the recognition unit 24 in accordance with the specific condition as described in the example of FIGS. 12 and 13. Alternatively, the route for transporting the banknotes in the collection process may be selected from the first route that passes through the recognition unit 24 and the second route that does not pass through the recognition unit 24 in accordance with the specific condition as described in the example of FIGS. 16 and 17. Further, the route for transporting the banknotes in the reconciliation process may be selected from the first route that passes through the recognition unit 24 and the second route that does not pass through the recognition unit 24 in accordance with the specific condition as described in the example of FIGS. 20 to 22.

In Step S15 subsequent to Step S13, the controller 15 executes the designated process by transporting the banknotes through the route determined in Step S13.

In Step S16, the controller 15 determines whether the external storage 35 is detached from the body of the apparatus based on the signal from the mount 293. If the external storage 35 is not detached (the answer is NO in Step S16), the flow proceeds to Step S17. If the external storage 35 is detached (the answer is YES in Step S16), the flow proceeds to Step S18. In Step S18, the controller 15 stops the process being executed. The flow proceeds to Step S12. If the external storage 35 is attached again, the flow proceeds from Step S13 to Step S15 to resume the process.

In Step S17, the controller 15 determines whether the designated process is finished or not. If the process is not finished yet (the answer is NO in Step S17), the flow returns to Step S15 and the process continues. If the process is finished (the answer is YES in Step S17), the flow ends.

In the above-described example, the setting unit 151 of the controller 15 sets the specific condition associated with each process every time the process is performed. The setting unit 151 may set the specific condition concerning the use environment of the banknote handling apparatus 1.

Information concerning the use environment includes items of location of use of the banknote handling apparatus 1, items of store, and items of target user.

The “items of location of use” correspond to items of information concerning the location where the banknote handling apparatus 1 is used. Examples thereof include a country or region to which the location where the banknote handling apparatus 1 is used belongs, and the location of the banknote handling apparatus 1 in a facility.

The “items of store” correspond to items of information concerning the store where the banknote handling apparatus 1 is installed. Examples thereof include a category of business of the store where the banknote handling apparatus 1 is installed.

The “items of target user” correspond to items of information concerning the target user of the banknote handling apparatus 1. Examples thereof include a category of the target user of the banknote handling apparatus 1.

The setting unit 151 may set a specific condition. For example, if a human with predetermined authority collects the banknotes, the banknote handling apparatus 1 selects the route that does not pass through the recognition unit 24 to perform the collection process, and if a human without the predetermined authority collects the banknotes, the banknote handling apparatus 1 selects the route that passes through the recognition unit 24 to perform the collection process. In this case, whether the human has the predetermined authority or not can be determined through identification via the terminal 16, for example. In accordance with the result of the identification and the specific condition concerning the category of the target user, the controller 15 automatically selects either the route that passes through the recognition unit 24 shown in FIG. 16 or the route that does not pass through the recognition unit 24 shown in FIG. 17.

Further, the setting unit 151 may set another specific condition. For example, if the banknote handling apparatus 1 is installed in a bank, the high-level reconciliation process is selected, and if the banknote handling apparatus 1 is installed in a retail store, the mid-level reconciliation process is selected.

If the bank is registered as the location of use of the banknote handling apparatus 1 at the initialization of the banknote handling apparatus 1, the controller 15 automatically selects the route that passes through the recognition unit 24 as in the example of FIG. 20, for example, to perform the reconciliation process. If the retail store is registered as the location of use of the banknote handling apparatus 1 at the initialization of the banknote handling apparatus 1, the controller 15 automatically selects the route that passes through the recognition unit 24 for the primary transport, and the route that does not pass through the recognition unit 24 for the secondary transport as in the example of FIG. 21, for example, to perform the reconciliation process.

Alternatively, the setting unit 151 may set another specific condition. For example, if the banknote handling apparatus 1 is installed in a certain country, the high-level reconciliation process is selected, and if the banknote handling apparatus 1 is installed in other countries than the certain country, the mid-level reconciliation process is selected.

### (Second Configuration Example of Banknote Handling Apparatus)

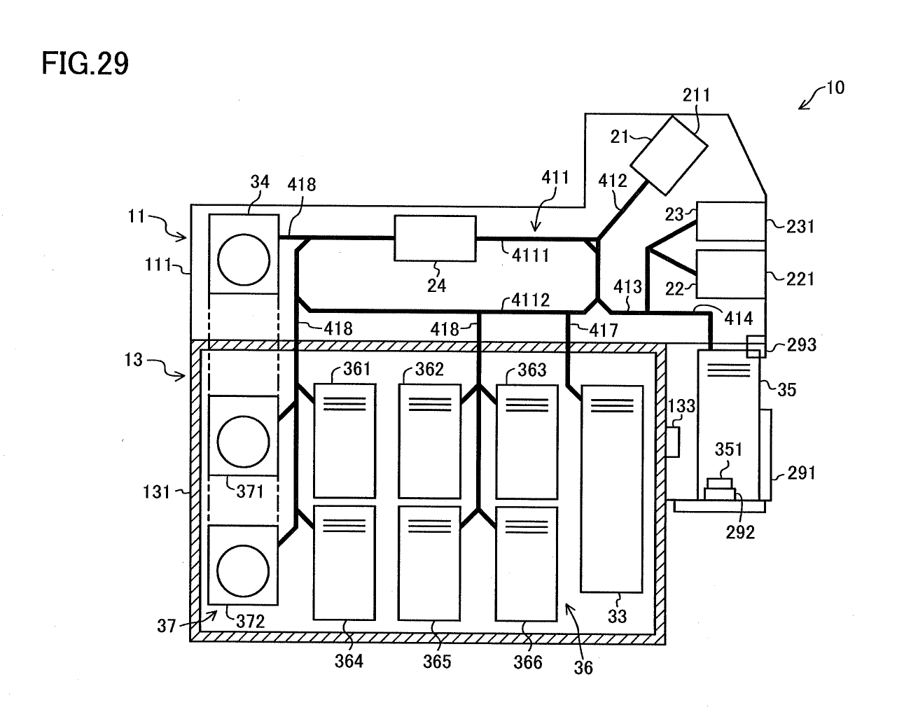

FIG. 29 illustrates a second configuration example of a banknote handling apparatus 10. In the second configuration example, the same components as those of the banknote handling apparatus 1 shown in FIGS. 2 to 4 will be designated by the same reference characters.

The banknote handling apparatus 10 differs from the banknote handling apparatus 1 in the configuration of the storages in the safe housing 131. Specifically, the banknote handling apparatus 10 includes two winding storages 37, six stacking storages 36, and a single multi-purpose storage 33. Just like in the banknote handling apparatus 1 described above, the external storage 35 is attachable to and detachable from the front side of the body of the banknote handling apparatus 10 via the attachment 291.

Each winding storage 37 may be, for example, a mixed storage which stores banknotes of a plurality of denominations in a mixed state. As described above, the winding storage can store and feed the banknotes with reliability irrespective of the size of the banknotes. The winding storage 37 is therefore suitably used as the mixed storage.

The winding storage 37 may be used as an unfit note storage which stores unfit banknotes, for example. The unfit note storage stores banknotes of various different denominations, i.e., banknotes of different sizes. The winding storage 37 is therefore suitably used as the unfit note storage.

The two winding storages, namely, the first and second storages 371 and 372, are arranged in the vertical direction in a rear portion of the inside of the safe housing 131. The first and second storages 371 and 372 are arranged at the same position in the longitudinal direction as the temporary storage 34 which is also a winding storage. That is, as indicated by chain double-dashed lines in FIG. 29, the three winding storages are arranged in the vertical direction in the rear portion of the banknote handling apparatus 1. Arranging the storages of the same size in the vertical direction advantageously downsizes the banknote handling apparatus 1. The three winding storages may be slightly misaligned with each other in the longitudinal direction.

Also in the second configuration example, the temporary storage 34 is an optional component which is attachable to and detachable from the banknote handling apparatus 10.

The first and second winding storages 371 and 372 disposed in the safe housing 131 are disposed adjacent to the temporary storage 34. If the winding storage 37 is used as a mixed storage and from which the banknotes are dispensed, some banknotes which are fed from the mixed storage but not supposed to be dispensed are stored in the temporary storage 34, and only the banknotes which are supposed to be dispensed are transported to the first dispensing unit 22 after passing through the recognition unit 24 and the connection path 413. The mixed storage and the temporary storage 34 disposed adjacent to each other allow the banknotes stored in the mixed storage to be dispensed in a short time.

The first and second winding storages 371 and 372 disposed in the safe housing 131 are arranged in a rear portion of the inside of the safe housing 131. For example, if an abnormal event such as jamming of the banknotes has occurred, the door of the safe housing 131 is opened and the storages in the safe housing 131 are drawn forward of the apparatus to resolve the abnormality. The unfit note storage is less frequently detached from or attached to the apparatus than the other storages, such as a storage which stores the banknotes sorted by denomination, for example. Thus, in a preferred embodiment, the first and second winding storages 371 and 372 are disposed in the rear portion of the inside of the safe housing 131 as shown in FIG. 29.

The winding storages 37 may be undetachable from the safe housing 131. In contrast, the stacking storages 36 may be detachable from and attachable to the safe housing 131. The winding storages 37 undetachable from the safe housing 131 are arranged in the rear portion of the inside of the safe housing 131, while the stacking storages 36 detachable from and attachable to the safe housing 131 are arranged forward of the winding storages 37. This allows a user to access the stacking storages 36 more easily, thereby improving ease of maintenance.

Among the stacking storages 36, the first, second, and third stacking storages 361, 362, and 363 are arranged in the longitudinal direction above the fourth, fifth, and sixth stacking storage 364, 365, and 366 arranged in the longitudinal direction. The stacking storages 36 have a larger capacity than the winding storages 37. The stacking storages 36 store the banknotes sorted by denominations, for example.

A multi-purpose storage 33 is disposed in a front portion in the inside of the safe housing 131. The multi-purpose storage 33 is a stacking storage. The multi-purpose storage 33 has the maximum capacity which is the largest among the other storages.

In the configuration example of FIG. 29, the first and second winding storages 371 and 372 and the first and fourth stacking storages 361 and 364 are connected to the loop transport path 411 via the connection path 418. The connection path 418 extends between the first and second winding storages 371 and 372 and the first and fourth stacking storages 361 and 364.

The second, third, fifth, and sixth stacking storages 362, 363, 365, and 366 are connected to the loop transport path 411 via the connection path 418. The connection path 418 extends between the second and fifth stacking storages 362 and 365 and the third and sixth stacking storages 363 and 366.

The banknotes travel in the same manner as in the examples shown in FIGS. 6 to 27 when the banknote handling apparatus 10 performs the processes described above. Typical examples of how the banknotes travel in the depositing process, the dispensing process, the replenishment process, the collection process, and the reconciliation process performed by the banknote handling apparatus 10 will be described below with reference to the drawings.

### (Depositing Process)

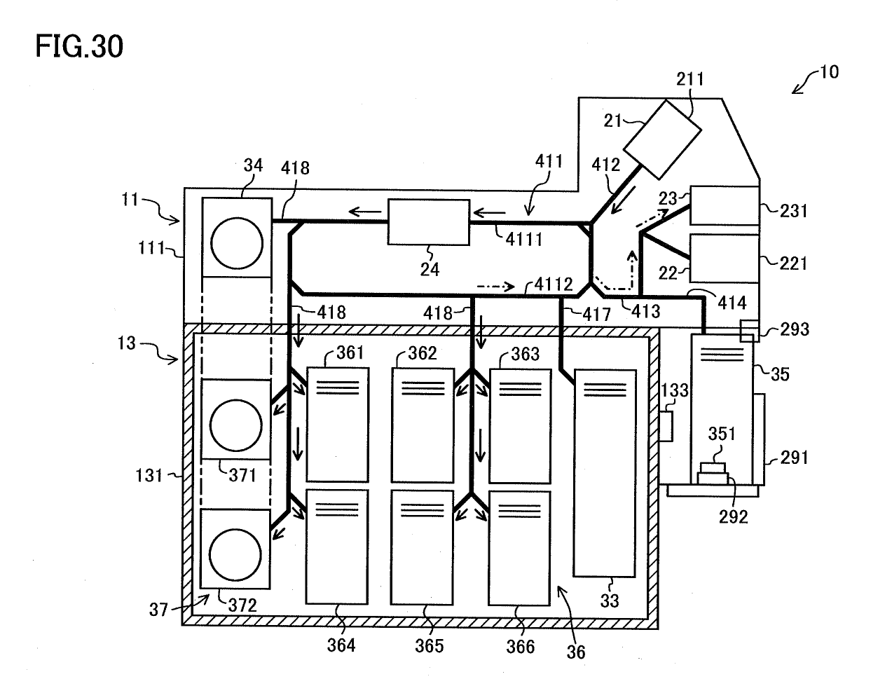

FIG. 30 shows an example of how the banknotes travel in the banknote handling apparatus 10 performing the depositing process. The depositing unit 21 takes the banknotes which are to be deposited and placed in the depositing unit 21 into the apparatus one by one. The transporter 4 transports the banknotes to the recognition unit 24 through the connection path 412 and the upper path 4111 of the loop transport path 411. The recognition unit 24 recognizes the banknotes. The transporter 4 transports the banknotes that have passed through the recognition unit 24 to an associated one of the winding storages 37 or an associated one of the stacking storages 36 corresponding to the result of the recognition through the loop transport path 411 and the connection path 418 (see solid line arrows in FIG. 30). The winding storage 37 or the stacking storage 36 stores the banknotes.

If some banknotes are recognized by the recognition unit 24 as banknotes to be rejected, the transporter 4 transports the rejected banknotes to the second dispensing unit 23 through the lower path 4112 of the loop transport path 411 and the connection path 413 as indicated by dashed line arrows in FIG. 30. After all the banknotes placed in the depositing unit 21 are taken into the apparatus, the banknotes dispensed to the second dispensing unit 23 are manually placed in the depositing unit 21 and taken into the apparatus again.

The depositing process ends when a human operates the terminal 16 or the operation unit 27 to confirm the depositing process after all the banknotes placed in the depositing unit 21 are taken into the apparatus.

If the human cancels the depositing process, the winding storage 37 or the stacking storage 36 feeds the banknotes stored therein, and the transporter 4 transports the fed banknotes to the first dispensing unit 22 in accordance with the example of FIG. 8. Thus, the banknotes to be deposited are returned.

In the example shown in FIG. 30, the banknotes to be deposited are directly stored in the winding storage 37 or the stacking storage 36. However, the banknotes to be deposited may be once stored in the temporary storage 34 after the recognition by the recognition unit to 24, and then fed from the temporary storage 34 after the confirmation of the depositing process. Then, the transporter 4 may transport the banknotes to the winding storage 37 or the stacking storage 36.

### (Dispensing Process)

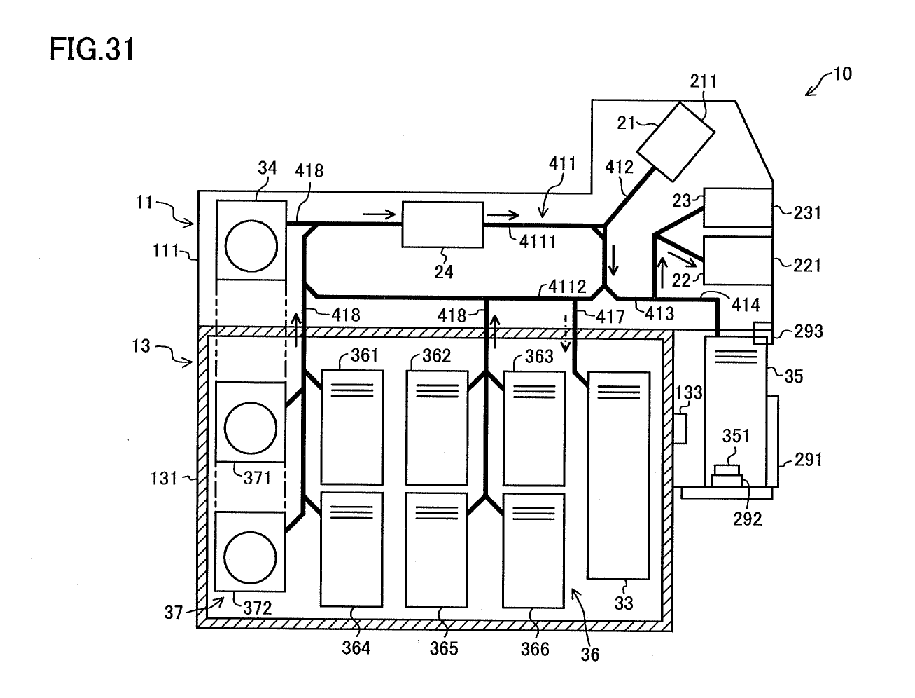

FIG. 31 shows an example of how the banknotes travel in the banknote handling apparatus 10 performing the dispensing process. The banknotes to be dispensed are fed from the winding storage 37 or the stacking storage 36 as indicated by solid line arrows in FIG. 31.

As indicated by the solid line arrows, the transporter 4 transports the banknotes to the recognition unit 24 through the connection path 418 and the loop transport path 411. The recognition unit 24 recognizes the banknotes. The transporter 4 transports the recognized banknotes to the first dispensing unit 22 through the loop transport path 411 and the connection path 413.

If some banknotes are recognized by the recognition unit 24 as banknotes to be rejected, the transporter 4 transports the rejected banknotes the multi-purpose storage 33 through the lower path 4112 of the loop transport path 411 and the connection path 417 as indicated by dashed line arrows. The multi-purpose storage 33 stores the rejected banknotes. The dispensing process ends when a designated amount of the banknotes is dispensed to the first dispensing unit 22.

### (Replenishment Process)

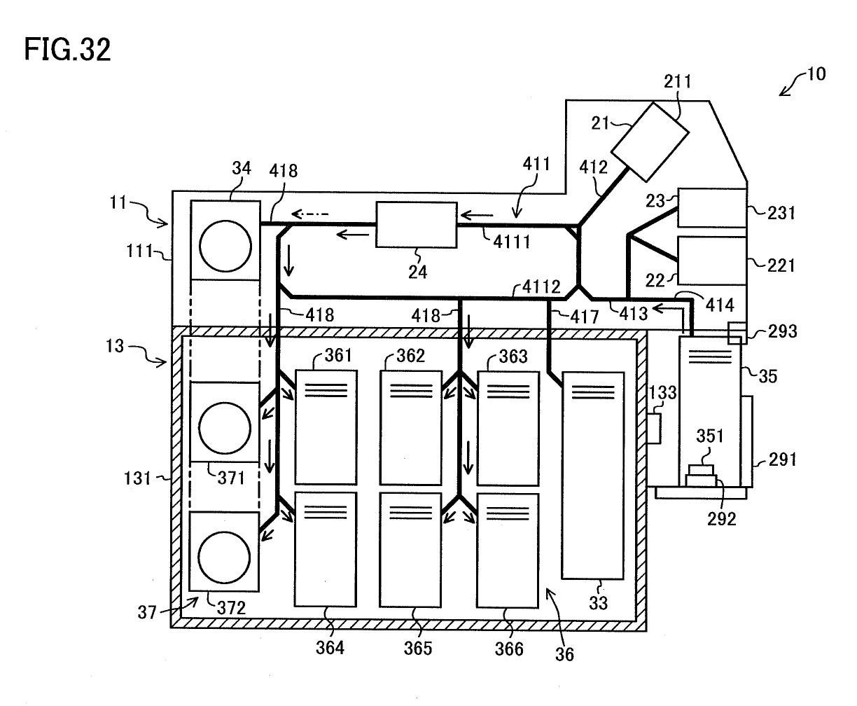

FIG. 32 shows an example of how the banknotes travel in the replenishment process using the external storage 35. The replenishment process can start when the external storage 35 storing banknotes for replenishment is attached to the body of the apparatus.

When the replenishment process starts, the external storage 35 feeds the banknotes as indicated by solid line arrows in FIG. 32. The transporter 4 transports the banknotes to the recognition unit 24 through the connection paths 414 and 413 and the upper path 4111 of the loop transport path 411. The recognition unit 24 recognizes the banknotes. The transporter 4 transports the banknotes to the winding storage 37 or the stacking storage 36 through the connection path 418 in accordance with the result of the recognition. The winding storage 37 or the stacking storage 36 stores the banknotes.

If some banknotes are rejected during the replenishment process, the transporter 4 transports the rejected banknotes to the temporary storage 34 as indicated by dashed line arrows. The transporter 4 may transport the rejected banknotes to the multi-purpose storage 33. Alternatively, the transporter 4 may transport the rejected banknotes to the second dispensing unit 23.

In the example of FIG. 32, the transporter 4 transports the banknotes for replenishment to the winding storage 37 or the stacking storage 36 through the route that passes through the recognition unit 24. As described above, if the banknote handling apparatus 10 has already acquired data about the banknotes for replenishment from the memory 351 of the external storage 35 or using any other means, the transporter may transport the banknotes for replenishment through the route that does not pass through the recognition unit 24 in accordance with the example shown in FIG. 13. If designated by a human operating the terminal 16 or the operation unit 27, the transporter may transport the banknotes for replenishment through the route that does not pass through the recognition unit 24 in accordance with the example of FIG. 13.

Note that in the banknote handling apparatus 10, the replenishment process using the depositing unit 21 may be performed in accordance with the example shown in FIG. 10, and the replenishment process using the banknotes stored in the multi-purpose storage 33 as the banknotes for replenishment may be performed in accordance with the example shown in FIG. 11.

### (Collection Process)

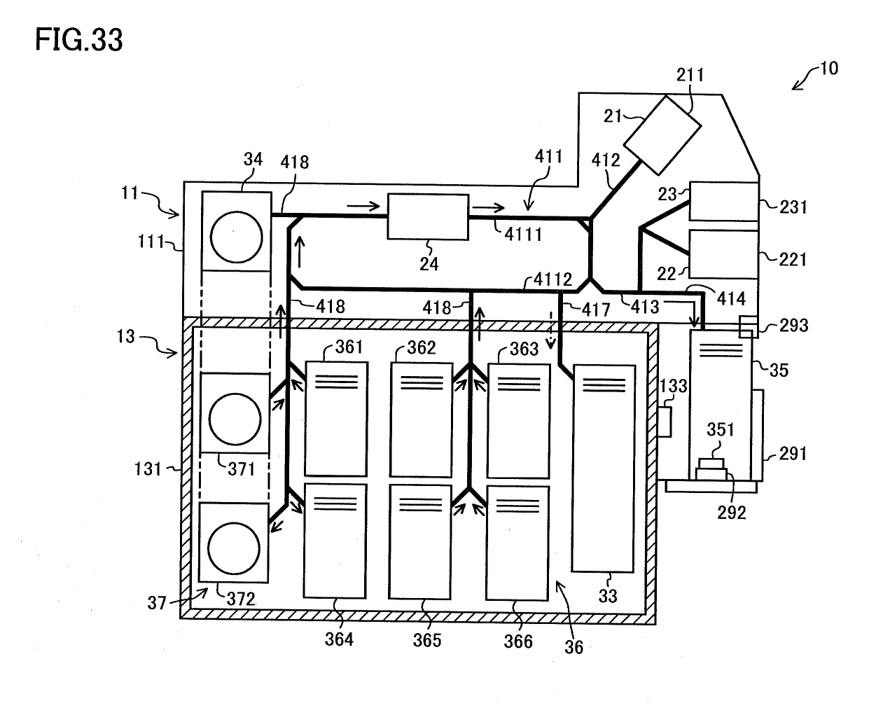

FIG. 33 shows an example of how the banknotes travel during the collection process using the external storage 35. The collection process can start when the external storage 35 is attached to the body of the apparatus.

When the collection process starts, the winding storage 37 or the stacking storage 36, from which the banknotes are to be collected, feeds the banknotes as indicated by solid line arrows in FIG. 33. The transporter 4 transports the banknotes to the recognition unit 24 through the connection path 418 and the loop transport path 411. The recognition unit 24 recognizes the banknotes. The transporter 4 transports the banknotes that have passed through the recognition unit 24 to the external storage 35 through the loop transport path 411 and the connection paths 413 and 414. The external storage 35 stores the banknotes.

The transporter 4 transports banknotes recognized as banknotes to be rejected by the recognition unit 24 to the multi-purpose storage 33 through the lower path 4112 of the loop transport path and the connection path 417 as indicated by dashed line arrows in FIG. 33. The multi-purpose storage 33 stores the rejected banknotes.

In collecting a designated number of banknotes, if the designated number of banknotes to be collected is small, or designated by the operator, the transporter 4 may transport the banknotes to the external storage 35 through the route that does not pass through the recognition unit 24, i.e., through the lower path 4112 of the loop transport path 411.

In the banknote handling apparatus 10, the collection process of storing the banknotes to be collected in the multi-purpose storage 33 may be performed in accordance with the example shown in FIG. 18.

The process of collecting the banknotes stored in the multi-purpose storage 33 in the external storage 35 may be performed in accordance with the example shown in FIG. 19.

### (Reconciliation Process)

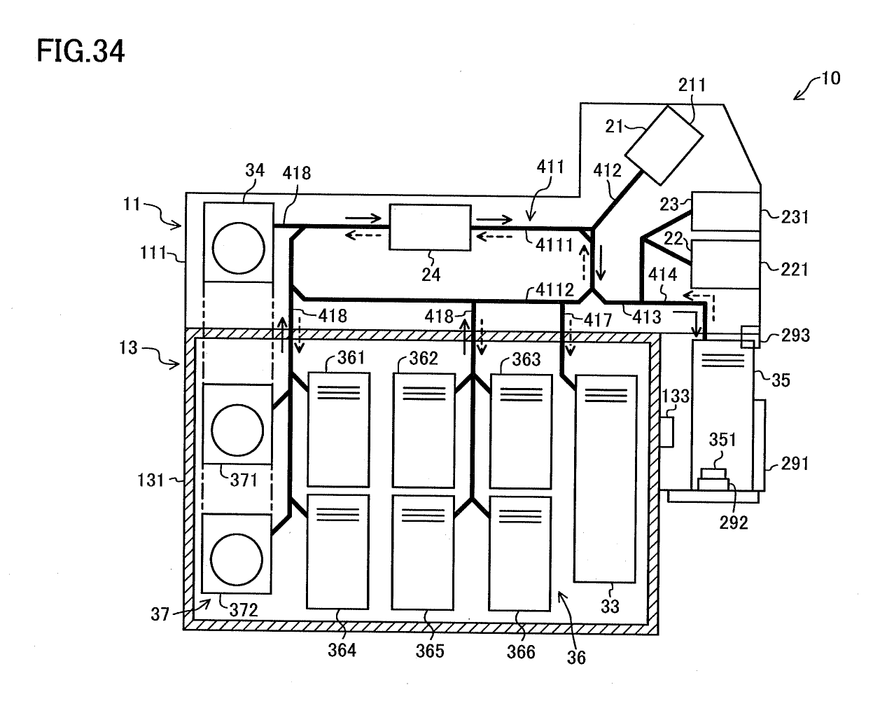

FIG. 34 shows an example of how the banknotes travel during the reconciliation process using the external storage 35. FIG. 34 shows an example of how the banknotes travel in a high-level reconciliation process. The reconciliation process can start when the external storage 35 is attached to the body of the apparatus.

The winding storage 37 or the stacking storage 36, which is the target of the reconciliation, feeds the banknotes as indicated by solid line arrows in FIG. 34. The transporter 4 transports the banknotes to the recognition unit 24 through the connection path 418 and the loop transport path 411. The recognition unit 24 recognizes the banknotes. The transporter 4 transports the banknotes that have passed through the recognition unit 24 to the external storage 35 through the loop transport path 411 and the connection paths 413 and 414 (i.e., the primary transport). The external storage stores the banknotes.

In the example of FIG. 34, the reconciliation process is sequentially performed on a plurality of storages, and is last performed on multi-purpose storage 33. The transporter 4 transports rejected banknotes to the multi-purpose storage 33 as indicated by dashed line arrows. The transporter 4 may transport the rejected banknotes to the second dispensing unit 23 in accordance with the example shown in FIG. 23. Alternatively, the transporter 4 may transport the rejected banknotes to the temporary storage 34 in accordance with the example shown in FIG. 24.

When the banknotes fed from the storage as the target of the reconciliation have been stored in the external storage 35, the external storage 35 feeds the banknotes. As indicated by the solid line arrows in FIG. 34, the transporter 4 transports the banknotes to the recognition unit 24 through the connection paths 414 and 413 and the loop transport path 411. The recognition unit 24 recognizes the banknotes again. The transporter 4 returns the banknotes that have passed through the recognition unit 24 to the storage through the loop transport path 411 and the connection path 418 (i.e., the secondary transport).

The reconciliation process ends when the banknotes fed from the external storage 35 are returned to the storage, and the inventory amount of the storage is accepted.

If the reconciliation process is sequentially performed on a plurality of storages, the reconciliation process including the primary transport and the secondary transport described above is sequentially performed.

The reconciliation process on the multi-purpose storage 33 may be performed in accordance with the example of FIG. 23 or 24.

FIG. 34 shows an example of how the banknotes travel in the high-level reconciliation process. To perform a mid-level reconciliation process, the transporter 4 may transport the banknotes in accordance with the example of FIG. 21. To perform a low-level reconciliation process, the transporter 4 may transport the banknotes in accordance with the example of FIG. 22.

As described above, in performing the reconciliation process on one or some winding storages 37 and/or one or some stacking storages 36, the transporter 4 may transport the rejected banknotes to the storage on which the reconciliation process is performed last in accordance with the example of FIG. 25.

The banknote handling apparatus 10 may perform the reconciliation process using an available capacity of any other storage than the storage which is the target of the reconciliation in accordance with the example of FIG. 26.

Alternatively, the banknote handling apparatus 10 may perform the reconciliation process using the temporary storage 34 in accordance with the example of FIG. 27.

### (Third Configuration Example of Banknote Handling Apparatus)

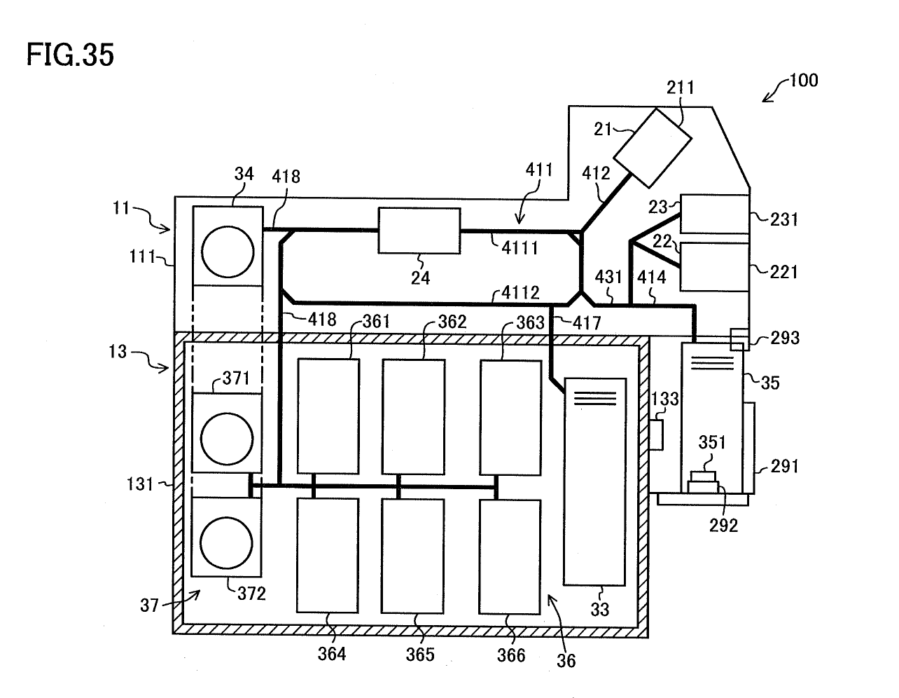

FIG. 35 illustrates a third configuration example of a banknote handling apparatus 100. In the third configuration example, how the storages are configured and arranged is the same as in the second configuration example. The third configuration example is different from the second configuration example in the structure of the connection path 418 connecting each storage and the loop transport path 411. In the banknote handling apparatus 100 of the third configuration example, the same components as those of the banknote handling apparatus 10 of the second configuration example will be designated by the same reference characters.

The banknote handling apparatus 100 includes a reduced number of connection paths 418. Specifically, the loop transport path 411 is connected to the winding storages 37 and the stacking storages 36 via a single connection path 418. The connection path 418 is branched to be connected to each storage. Branches of the connection path 418 extend between the storages arranged in the vertical direction, and extend in the longitudinal direction of the apparatus.

During each process performed by the banknote handling apparatus 100, the banknotes travel substantially in the same manner as in the banknote handling apparatus 10. During each process performed by the banknote handling apparatus 100, the banknotes travel in a manner similar to that in the banknote handling apparatus 1.

### (Fourth Configuration Example of Banknote Handling Apparatus)

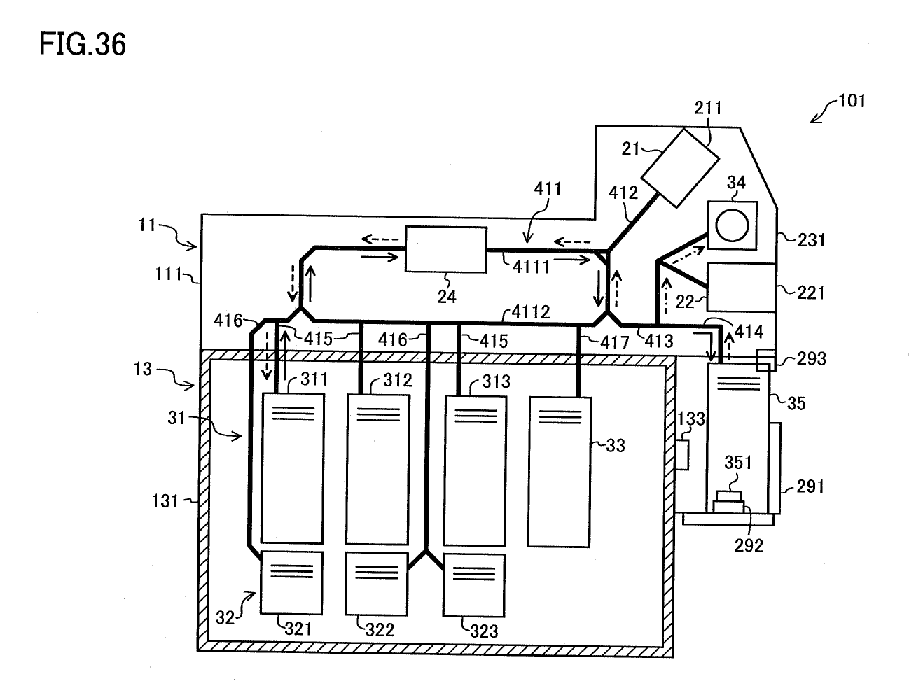

FIG. 36 illustrates a fourth configuration example of a banknote handling apparatus 101. In the fourth configuration example, the temporary storage 34 is disposed at a position different from that in the first configuration example shown in FIG. 4. In the banknote handling apparatus 101 of the fourth configuration example, the same components as those of the banknote handling apparatus 1 of the first configuration example will be designated by the same reference characters.

The temporary storage 34 of the banknote handling apparatus 101 is disposed at the position of the second dispensing unit 23 of the banknote handling apparatus 1. The banknote handling apparatus 101 does not have the second dispensing unit 23. In the banknote handling apparatus 101, banknotes rejected in the depositing process may be transported to, for example, the first dispensing unit 22.

The temporary storage 34 is connected to the connection path 413. The temporary storage 34 and the external storage 35 are arranged on the same side of the recognition unit 24. Both of the temporary storage 34 and the external storage 35 are connected to the loop transport path 411 between the recognition unit 24 and the multi-purpose storage 33.

Arrows shown in FIG. 36 indicate an example of how the banknotes travel during the reconciliation process using the external storage 35. FIG. 36 shows an example of how the banknotes travel in a high-level reconciliation process. The reconciliation process can start when the external storage 35 is attached to the body of the apparatus.

The large or small storage 31 or 32, which is the target of the reconciliation, feeds the banknotes as indicated by solid line arrows in FIG. 36. The transporter 4 transports the banknotes to the recognition unit 24 through the connection path 415 or 416 and the loop transport path 411. The recognition unit 24 recognizes the banknotes. The transporter 4 transports the banknotes that have passed through the recognition unit 24 to the external storage 35 through the loop transport path 411 and the connection paths 413 and 414 (i.e., the primary transport). The external storage 35 stores the banknotes.

The transporter 4 transports banknotes recognized as banknotes to be rejected to the temporary storage 34 through the connection path 413 as indicated by dashed line arrows.

When the banknotes fed from the storage as the target of the reconciliation have been stored in the external storage 35, the external storage 35 feeds the banknotes. As indicated by the dashed line arrows in FIG. 36, the transporter 4 transports the banknotes to the recognition unit 24 through the connection paths 414 and 413 and the loop transport path 411. The recognition unit 24 recognizes the banknotes again. The transporter 4 returns the banknotes that have passed through the recognition unit 24 to the storage through the loop transport path 411 and the connection path 415 or 416 (i.e., the secondary transport).

The transporter 4 may also transport banknotes rejected during the secondary transport to the temporary storage 34 through the connection path 413.

The temporary storage 34 feeds the stored banknotes after the secondary transport ends. The transporter 4 may transport the banknotes fed from the temporary storage 34 to the multi-purpose storage 33 to be stored therein. The transporter 4 may transport the banknotes fed from the temporary storage 34 to the first dispensing unit 22 to be dispensed thereto. The transporter 4 may return the banknotes fed from the temporary storage 34 to the storage to be stored therein. Further, the transporter 4 may transport the banknotes fed from the temporary storage 34 to the recognition unit 24, and transport the banknotes to an associated one of the storages corresponding to the result of the recognition to be stored therein.

If the reconciliation process is sequentially performed on a plurality of storages, the reconciliation process including the primary transport and the secondary transport described above is sequentially performed.

The reconciliation process can be performed in the same manner on the multi-purpose storage 33.

Although not shown, during the mid-level reconciliation process performed by the banknote handling apparatus 101, the transporter 4 may transport banknotes rejected during the primary or secondary transport to the temporary storage 34.

During the reconciliation process in the banknote handling apparatus 101, the banknotes fed from the storage as the target of the reconciliation may be separately stored in the external storage 35 and the temporary storage 34. This is effective when the storage capacity of the external storage 35 is small.

When the banknote handling apparatus 101 performs other processes than the reconciliation process, the banknotes travel substantially in the same manner as in the banknote handling apparatus 1 except that the rejected banknotes are transported to the second dispensing unit 23.

### (Fifth Configuration Example of Banknote Handling Apparatus)

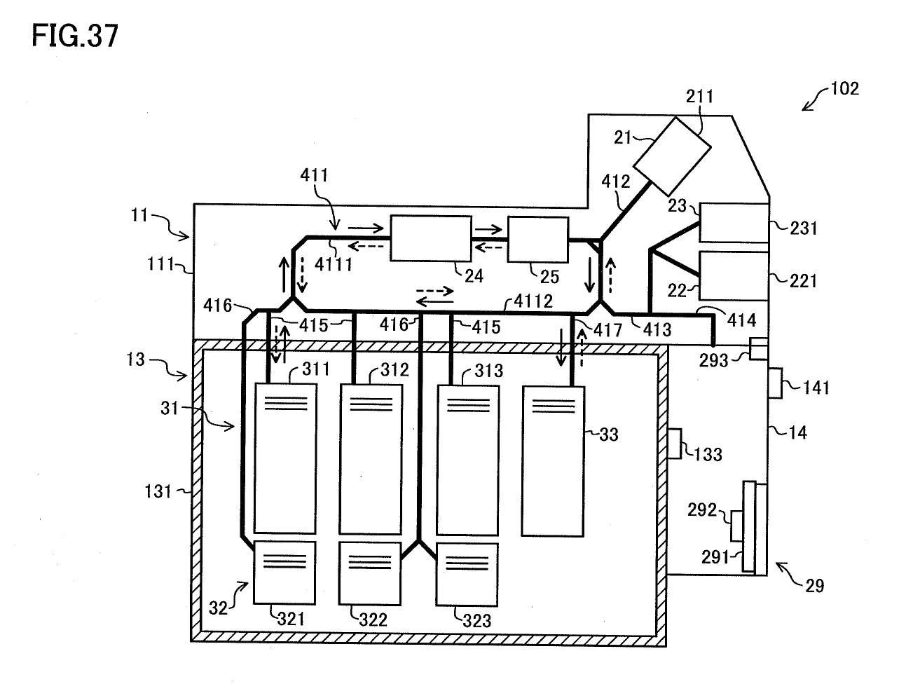

FIG. 37 illustrates a fifth configuration example of a banknote handling apparatus 102. The fifth configuration example differs from the first configuration example shown in FIG. 2 in that a slide unit 25 is added. In the banknote handling apparatus 102 of the fifth configuration example, the same components as those of the banknote handling apparatus 1 of the first configuration example will be designated by the same reference characters.

The slide unit 25 is a mechanism for moving each banknote on the transport path in the width direction of the transport path. The slide unit 25 can move the banknote to a desired position, such as the center, the right end, or the left end, of the transport path. The slide unit 25 is disposed on the upper path 4111. More specifically, as shown in FIG. 37, when the banknotes are being transported in the clockwise direction on the loop transport path 411, the slide unit 25 is located downstream of the recognition unit 24.

Arrows shown in FIG. 37 indicate an example of how the banknotes travel in the reconciliation process using an available capacity of the multi-purpose storage 33. FIG. 37 shows an example of how the banknotes travel in a high-level reconciliation process.

The large or small storage 31 or 32 which is the target of the reconciliation feeds the banknotes as indicated by solid line arrows in FIG. 37. The transporter 4 transports the banknotes to the recognition unit 24 through the connection path 415 or 416 and the loop transport path 411. The recognition unit 24 recognizes the banknotes. The slide unit 25 changes the position, in the width direction of the transport path, of each banknote that has passed through the recognition unit 24 as needed. Specifically, the banknotes to be stored in the multi-purpose storage 33 are moved to the center of the transport path in the widthwise direction. The transporter 4 transports the banknotes that have passed through the slide unit 25 to the multi-purpose storage 33 through the loop transport path 411 and the connection path 417 (i.e., the primary transport). The multi-purpose storage 33 stores the banknotes.

The multi-purpose storage 33 stores banknotes of different sizes. To prevent a failure in the feeding of the banknotes from the multi-purpose storage 33, the banknotes to be stored in the multi-purpose storage 33 are preferably located at the center in the widthwise direction of the transport path. Specifically, the slide unit 25 can align the banknotes as the target of the reconciliation in the width direction before being stored in the multi-purpose storage 33.

The multi-purpose storage 33 may have a mechanism for adjusting the width or depth of the interior thereof so as to match with the size of the banknotes to be stored therein.

When the banknotes fed from the storage as the target of the reconciliation are stored in the multi-purpose storage 33, the banknote handling apparatus 102 performs the secondary transport. The multi-purpose storage 33 feeds the banknotes. As indicated by dashed line arrows in FIG. 37, the transporter 4 transports the banknotes to the slide unit 25 through the connection path 417 and the loop transport path 411. The slide unit 25 does not move the banknotes during the secondary transport. The recognition unit 24 recognizes again the banknotes that have passed through the slide unit 25. The transporter 4 returns the banknotes that have passed through the recognition unit 24 to the storage through the loop transport path 411 and the connection path 415 or 416.

If the reconciliation process is sequentially performed on a plurality of storages, the reconciliation process including the primary transport and the secondary transport described above is sequentially performed.

Although not shown, when the banknote handling apparatus 102 performs the mid-level reconciliation process, the recognition unit 24 may recognize the banknotes, and the slide unit 25 may align the banknotes in the widthwise direction, during the primary transport.

When the banknote handling apparatus 102 performs other processes than the reconciliation process, the banknotes travel substantially in the same manner as in the banknote handling apparatus 1.

The present disclosure is not limited to the banknote handling apparatus which handles loose banknotes as described above, but may be applied to an apparatus which handles bundles of banknotes, for example. The present disclosure may also be applied to a coin handling apparatus. The coin handling apparatus is not limited to an apparatus which handles loose coins, but may be an apparatus which handles rolls of coins.

### DESCRIPTION OF REFERENCE CHARACTERS

1 Banknote Handling Apparatus (Money Handling Apparatus)
10 Banknote Handling Apparatus (Money Handling Apparatus)
100 Banknote Handling Apparatus (Money Handling Apparatus)
101 Banknote Handling Apparatus (Money Handling Apparatus)
102 Banknote Handling Apparatus (Money Handling Apparatus)
131 Safe Housing
132 Door
14 Cover
15 Controller (Controller)
151 Setting Unit
21 Depositing Unit
22 First Dispensing Unit
23 Second Dispensing Unit
24 Recognition Unit
292 Reader
31 Large Storage
32 Small Storage
33 Multi-Purpose Storage
34 Temporary Storage
35 External Storage (Removable Storage)
351 Memory

1. A money handling apparatus, comprising:
a first storage and a second storage each of which stores money;
a recognition unit which is operable to recognize the money passing therethrough;
a transporter which includes a first route for the money that passes through the recognition unit and a second route for the money that does not pass through the recognition unit, wherein the transporter is operable to transport the money from the first storage to the second storage along either the first route or the second route; and
a controller which, in a process of storing the money fed from the first storage into the second storage, selects either the first route or the second route for the money in accordance with a specific condition.

2. The money handling apparatus of claim 1, wherein
the second route is shorter than the first route.

3. The money handling apparatus of claim 1, wherein
one of the first storage and the second storage is disposed inside a safe housing, and
the other one of the first storage and the second storage is disposed outside the safe housing.

4. The money handling apparatus of claim 1, wherein
the controller selects either the first route or the second route in accordance with the specific condition in a replenishment process of storing the money fed from the first storage disposed outside the safe housing in the second storage disposed inside the safe housing.

5. The money handling apparatus of claim 4, wherein
the controller selects the second route if data about the money stored in the first storage has been acquired, and selects the first route if the data about the money stored in the first storage has not been acquired.

6. The money handling apparatus of claim 5, further comprising:
a reader which reads the data about the money stored in the first storage from a memory storing the data, wherein
the reader is disposed outside the safe housing.

7. (canceled)

8. The money handling apparatus of claim 1, wherein
the controller selects either the first route or the second route in accordance with the specific condition in a collection process of storing the money fed from the first storage disposed inside the safe housing into the second storage disposed outside the safe housing.

9. The money handling apparatus of claim 8, wherein
the controller selects the first route in collecting a designated number of the money from the first storage, and selects the second route in collecting all the money stored in the first storage.

10. The money handling apparatus of claim 8, wherein
the controller selects the first route if the number of the money to be collected from the first storage is less than a predetermined number, and selects the second route if the number of the money to be collected from the first storage is more than or equal to the predetermined number.

11. The money handling apparatus of claim 1, wherein
the controller selects either the first route or the second route in accordance with the specific condition in a reconciliation process of storing the money fed from the first storage into the second storage, and storing the money fed from the second storage into the first storage.

12. The money handling apparatus of claim 11, wherein
the controller selects either the first route or the second route in accordance with the specific condition in transporting the money from the first storage to the second storage, and in transporting the money from the second storage to the first storage.

13. The money handling apparatus of claim 12, wherein
in accordance with a reconciliation level of the reconciliation process, the controller selects the first route in transporting the money from the first storage to the second storage, and selects the first route in transporting the money from the second storage to the first storage.

14. The money handling apparatus of claim 12, wherein
in accordance with a reconciliation level of the reconciliation process, the controller selects the second route in transporting the money from the first storage to the second storage, and selects the second route in transporting the money from the second storage to the first storage.

15. The money handling apparatus of claim 12, wherein
in accordance with a reconciliation level of the reconciliation process, the controller selects either the first route or the second route in transporting the money from the first storage to the second storage, and selects the other one of the first route or the second route in transporting the money from the second storage to the first storage.

16. (canceled)

17. (canceled)

18. (canceled)

19. (canceled)

20. (canceled)

21. (canceled)

22. (canceled)

23. (canceled)

24. (canceled)

25. (canceled)

26. The money handling apparatus of claim 1, wherein
either the first storage or the second storage is a removable storage which is attachable to and detachable from a body of the apparatus outside a safe housing, and
the money handling apparatus further comprises a detection unit which is operable to detect that the removable storage is attached to the body of the apparatus.

27. The money handling apparatus of claim 26, wherein
the controller starts the process when the detection unit detects attachment of the removable storage.

28. The money handling apparatus of claim 26, wherein
the controller stops the process being currently performed when the detection unit detects detachment of the removable storage.

29. (canceled)

30. The money handling apparatus of claim 1, further comprising:
a setting unit which sets the specific condition.

31. The money handling apparatus of claim 1, wherein
the specific condition includes a condition concerning a use environment of the money handling apparatus.

32. A money handling method, comprising:
selecting either a first route that passes through a recognition unit or a second route that does not pass through the recognition unit in accordance with a specific condition in a process of storing money fed from a first storage in a second storage; and
transporting the money from the first storage to the second storage through the selected route, wherein
the recognition unit recognizes the money when the first route is selected, and
the recognition unit does not recognize the money when the second route is selected.
